(19) United States
(12) Patent Application Publication
(10) Pub. No.: US 2025/0350407 A1
(43) Pub. Date: Nov. 13, 2025

(54) COMMUNICATION MODULE AND OPERATING METHOD THEREOF

(71) Applicant: Samsung Electronics Co., Ltd., Suwon-si (KR)

(72) Inventor: Jonghyun BAIK, Suwon-si (KR)

(73) Assignee: Samsung Electronics Co., Ltd., Suwon-si (KR)

(21) Appl. No.: 19/015,130

(22) Filed: Jan. 9, 2025

(30) Foreign Application Priority Data
May 9, 2024 (KR) 10-2024-0061241

(51) Int. Cl. H04L 1/1812; H04L 1/1867

(52) U.S. Cl. CPC H04L 1/1816; H04L 1/1867

(57) ABSTRACT

A communication module including processing circuitry configured to control a transmission path of first data and first reliability data according to whether a plurality of input signals were retransmitted, the first data being generated based on phase difference data between the plurality of input signals inputted in time order, and the first reliability data corresponding to the first data, detect an error in a first data block based on the first data and the first reliability data, perform a combining operation on the first data, the first reliability data, storage data and storage reliability data to generate combining data and combining reliability data, the storage reliability data corresponding to the storage data, and the combining reliability data corresponding to the combining data, and perform a first error correction operation based on the combining data and the combining reliability data.

### CROSS-REFERENCE TO RELATED APPLICATION

This application claims priority to and the benefit of Korean Patent Application No. 10-2024-0061241 filed in the Korean Intellectual Property Office on May 9, 2024, the entire contents of which are incorporated herein by reference.

### BACKGROUND

### (a) Technical Field

The present disclosure relates to a communication module and an operating method thereof.

### (b) Description of the Related Art

Packets in wireless communication such as Bluetooth may include data for error detection in the packets, such as a cyclic redundancy check (CRC) code, to detect data errors, and a receiving device corrects data errors in the packets using the CRC code.

In addition, the efficiency of packet reception in wireless communication is being increased by utilizing hybrid automatic repeat request (HARQ) technology, which requests retransmission of packets when a receiving device is unable to correct the errors.

### SUMMARY

Embodiments provide a communication module and an operating method thereof in which the packet reception success rate is improved by performing error correction and error detection on repeat packets in a plurality of ways.

Embodiments provide a communication module and an operating method thereof with improved packet reception success rate by efficiently disposing components of HARQ technology.

Embodiments of the present disclosure provide a communication module including processing circuitry configured to control a transmission path of first data and first reliability data according to whether a plurality of input signals were retransmitted, the first data being generated based on phase difference data between the plurality of input signals inputted in time order, and the first reliability data corresponding to the first data, detect an error in a first data block based on the first data and the first reliability data, perform a combining operation on the first data, the first reliability data, storage data and storage reliability data to generate combining data and combining reliability data, the storage reliability data corresponding to the storage data, and the combining reliability data corresponding to the combining data, and perform a first error correction operation based on the combining data and the combining reliability data.

Embodiments provide a communication module including processing circuitry configured to generate bit data and bit reliability data based on phase difference data between a plurality of input signals inputted in time order, the bit reliability data corresponding to the bit data, control a transmission path of the bit data and the bit reliability data depending on whether the plurality of input signals were retransmitted, detect an error in a first data block based on the bit data and the bit reliability data, perform a combining operation on the bit data and storage bit data to generate combining bit data, the storage bit data corresponding to the bit data, perform a combining operation on the bit reliability data and storage bit reliability data to generate combining bit reliability data, the storage bit reliability data corresponding to the bit reliability data, and perform an error correction operation based on the combining bit data and the combining bit reliability data.

Embodiments provide an operating method of a communication module, including: generating first data and first reliability data based on phase difference data between a plurality of input signals inputted in time order, the first reliability data corresponding to the first data, detecting an error in a first data block based on the first data and the first reliability data in response to determining the plurality of input signals were retransmitted, performing a combining operation on the first data, the first reliability data, storage data and storage reliability data to generate combining data and combining reliability data in response to determining the plurality of input signals were retransmitted, the storage reliability data corresponding to the storage data, and the combining reliability data corresponding to the combining data, and performing an error correction operation based on the combining data and the combining reliability data to generate a combining data block, detecting an error in the combining data block, and requesting retransmission depending on whether at least one of error detection of the combining data block or error detection of the first data block succeeds.

Embodiments provide an application processor including: a system bus, a processor electrically connected to the system bus and including at least one processing core, and a communication module configured to receive phase difference data, perform an error correction operation based on the phase difference data to generate data and provide the data to the processor, wherein the communication module includes processing circuitry configured to control a transmission path of first data and first reliability data depending on whether the phase difference data were retransmitted, the first data being generated based on the phase difference data, and the first reliability data corresponding to the first data, detect an error in a first data block based on the first data and the first reliability data, combine the first data and storage data corresponding to the first data to generate combining data, combine the first reliability data and storage reliability data corresponding to the first reliability data to generate combining reliability data, and perform an error correction operation based on the combining data and the combining reliability data.

### BRIEF DESCRIPTION OF THE DRAWINGS

FIG. 1 illustrates a block diagram of a communication system according to embodiments.

FIG. 2 illustrates a block diagram of a demodulator module according to embodiments.

FIG. 3 illustrates a block diagram of an error correction module according to embodiments.

FIG. 4 illustrates a phase-domain error correction unit according to embodiments.

FIG. 5 illustrates a block diagram of an error correction module according to embodiments.

FIG. 6 illustrates a flowchart of an operating method of a demodulator module according to embodiments.

FIG. 7 to FIG. 12 are drawings for describing an operating method of a demodulator module according to embodiments.

FIG. 13 illustrates a block diagram of an error correction module according to embodiments.

FIG. 14 illustrates a block diagram of a Cartesian-domain error correction unit according to embodiments.

FIG. 15 illustrates a block diagram of an error correction module according to embodiments.

FIG. 16 illustrates a flowchart of an operating method of a demodulator module according to embodiments.

FIG. 17 is a drawing for describing an operating method of a demodulator module according to embodiments.

FIG. 18 is a drawing for describing a wireless communication device according to embodiments.

FIG. 19 is a drawing for describing a wireless communication device according to embodiments.

### DETAILED DESCRIPTION

The present disclosure will be described more fully hereinafter with reference to the accompanying drawings, in which embodiments of the disclosure are shown. As those skilled in the art would realize, embodiments may be modified in various different ways, all without departing from the spirit or scope of the present disclosure.

In order to clearly describe the present disclosure, parts or portions that are irrelevant to the description are omitted, and identical or similar constituent elements throughout the specification are denoted by the same reference numerals (or similar reference numerals).

In addition, unless explicitly described to the contrary, the word “comprise” and variations such as “comprises” or “comprising” will be understood to imply the inclusion of stated elements but not the exclusion of any other elements.

It will be further understood by those within the art that if a specific number is intended to be recited in a claim limitation, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

Furthermore, in those instances where a convention analogous to “at least one of A, B, or C” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In embodiments of the disclosure, the terms “module”, “unit” and/or “part” are terms to refer to an element performing at least one function or operation and may be implemented as hardware, or a combination of hardware and software.

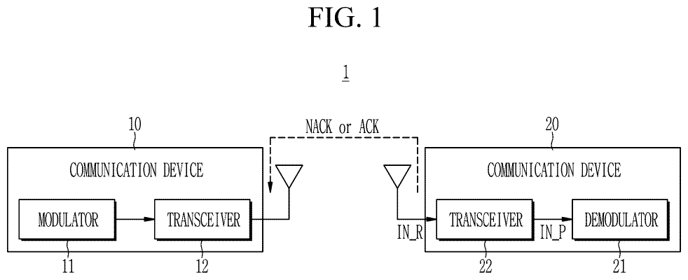

FIG. 1 illustrates a block diagram of a communication system according to embodiments.

Referring to FIG. 1, a communication system 1 may include a first communication device 10 and a second communication device 20 that communicate wirelessly through a channel.

The communication system 1 may be any system for wireless communication. In embodiments, as a non-limiting example, the communication system 1 may be a wireless communication system such as a 5th generation wireless (5G) system, a long term evolution (LTE) system, Bluetooth, WiFi, etc. According to embodiments, the communication system 1 may be a wired communication system such as a storage system, a network system, or the like. Hereinafter, the communication system 1 will be described with reference to a wireless communication system, but the technical idea of the present disclosure is not limited to the disclosed examples.

For example, the first communication device 10 may be a base station or a component included in the base station. The base station may refer to a fixed station that communicates with a terminal and/or another base station, and may communicate with a terminal and/or another base station to transmit/receive data and/or control information. The base station may be referred to as a Node B, an evolved-Node B, a base transceiver system (BTS), an access point (AP), a relay node, a remote radio head (RRH), a radio unit (RU), a small cell, or the like.

For example, the second communication device 20 may be a terminal or a component included in the terminal. The terminal is a wireless communication device and may refer to various devices capable of transmitting and receiving data and/or control information by communicating with the first communication device 10. For example, the terminal may be referred to as a user equipment, a mobile station (MS), a mobile terminal (MT), a user terminal (UT), a subscription station (SS), a wireless device, a handheld device, and the like. According to embodiments, the first communication device 10 may be a terminal or a component included in the terminal, and the second communication device 20 may be a base station or a component included in the base station.

According to embodiments, both the first communication device 10 and the second communication device 20 may be a terminal or a component included in the terminal.

A wireless communication network between the first communication device 10 and the second communication device 20 may support a plurality of users to communicate by sharing available network resources. For example, in a wireless communication network, information may be transmitted in various ways, such as code division multiple access (CDMA), frequency division multiple access (FDMA), time division multiple access (TDMA), orthogonal frequency division multiple access (OFDMA), single carrier division multiple Access (SC-FDMA), etc.

The first communication device 10 and the second communication device 20 may communicate with each other through uplink (UL) and downlink (DL). In wireless systems such as an LTE system and an LTE-advanced system, uplink and downlink may transmit control information through control channels such as a physical downlink control channel (PDCCH), physical control format indicator channel (PCFICH), physical hybrid ARQ indicator channel (PHICH), physical uplink control channel (PUCCH), and enhanced physical downlink control channel (EPDCCH), and may transmit data through data channels such as a physical downlink shared channel (PDSCH) and physical uplink shared channel (PUSCH). In addition, control information may be transmitted using enhanced PDCCH or extended PDCCH (EPDCCH).

According to embodiments, each of the first communication device 10 and the second communication device 20 may be a user equipment device, and may transmit and receive information through communication methods such as Bluetooth and near field communication (NFC). Each of the communication devices 10 and 20 may include a Bluetooth module for using Bluetooth and/or an NFC module for using NFC. The first communication device 10 may generate an RF signal IN_R corresponding to the generated information and transmit the RF signal IN_R to the outside (e.g., outside of the communication device 10) through at least one antenna. The second communication device 20 may receive the RF signal IN_R through at least one antenna, and may provide information corresponding to the RF signal IN_R to a processor included in the second communication device 20.

The first communication device 10 may include a modulator module 11, a transceiver 12, and/or an antenna. In embodiments, the modulator module 11 and the transceiver 12 may include some components of the Bluetooth module for using Bluetooth, but are not limited thereto.

The modulator module 11 may convert digital data into an analog signal. For example, when the modulator module 11 modulates digital data into an analog signal using a differential phase shift keying (DPSK) method, the modulator module 11 may generate an analog signal having a phase difference corresponding to the digital data.

The transceiver 12 may perform frequency-time conversion on a transmitted signal or time-frequency conversion on a received signal, and in embodiments, may perform a frequency up-conversion operation to generate the RF signal IN_R. The first communication device 10 may transmit the RF signal IN_R through a transmission antenna. In embodiments, a frequency range of the RF signal IN_R may be within 2.3 GHz to 2.5 GHZ, but the technical idea of the present disclosure is not limited to the above frequency example.

The second communication device 20 may include a demodulator module 21, a transceiver 22, and/or an antenna. The second communication device 20 may receive the RF signal IN_R through a receiving antenna. In embodiments, the demodulator module 21 and the transceiver 22 may include some components of the Bluetooth module for using Bluetooth, but are not limited thereto.

The transceiver 22 of the second communication device 20 may obtain a signal of a frequency to be read by performing time-frequency conversion on the received RF signal IN_R. In embodiments, the transceiver 22 may include an analog down-conversion mixer and may generate a baseband signal by down-converting the frequency of the received signal (or data signal).

In embodiments, the demodulator module 21 may receive the baseband signal obtained by the transceiver 22 as an input signal IN_P, and generate digital data based on the same. For example, when the demodulator module 21 demodulates digital data from an analog signal in a differential phase shift keying (DPSK) method, digital data may be generated based on a phase difference between analog signals continuously received in time order.

In embodiments, the demodulator module 21 may perform a soft decision operation based on the phase difference during the demodulation operation to generate digital data and reliability data corresponding to the digital data. The demodulator module 21 may perform an error correction operation based on the reliability data.

In embodiments, unlike those shown in FIG. 1, some components included in the demodulator module 21 may be separately disposed and included in the transceiver 22.

According to embodiments, the first and second communication devices 10 and 20 may transmit and receive data in packet units, thereby transmitting and receiving data blocks including a plurality of bit data. According to embodiments, the second communication device 20 may use HARQ technology to correct errors occurring in a respective one of the data blocks during the demodulation operation or to request retransmission if correction is not possible.

To illustrate FIG. 1, the second communication device 20 may receive the RF signal IN_R from the first communication device 10, perform an error correction operation on the data block on the RF signal IN_R, and provide the first communication device 10 with a positive acknowledgment ACK indicating the success of packet transmission when error detection of the data block is not detected or error correction is performed without error correction. When the error of the data block with respect to the RF signal IN_R may not be corrected, the second communication device 20 may request retransmission by providing a negative acknowledgment NACK including (e.g., indicating) a failure of packet transmission to the first communication device 10.

According to embodiments, the demodulator module 21 may detect an error in a data block within the retransmitted packet in a parallel manner for the retransmitted packet, perform a combining operation with the previously received packet, and then perform an error correction operation to detect an error in the generated data block. According to embodiments, the demodulator module 21 may perform error correction and error detection on the retransmitted packets in parallel to improve the reception success rate of packet transmission.

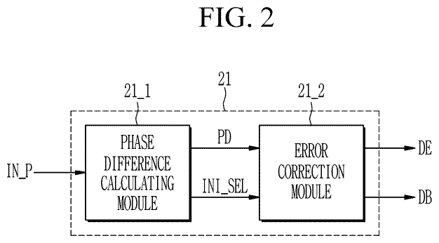

FIG. 2 illustrates a block diagram of a demodulator module according to embodiments.

Referring to FIG. 1 and FIG. 2, the demodulator module 21 may include a phase difference calculating module 21_1 and an error correction module 21_2. According to embodiments, the phase difference calculating module 21_1 and the error correction module 21_2 may be separated and disposed in different modules or different chips. For example, the phase difference calculating module 21_1 may be disposed in the transceiver 22, and the error correction module 21_2 may be disposed in an application processor (AP) as one functional block. The error correction module 21_2 may perform a demodulation operation by receiving phase difference data PD and an initial input selection signal INI_SEL outputted by the phase difference calculating module 21_1 disposed outside the application processor. According to embodiments, each of the phase difference calculating module 21_1 and the error correction module 21_2 may be implemented as an individual communication module in the second communication device 20.

However, the technical idea of the present disclosure is not limited to the example of the above disposition, and in embodiments, the phase difference calculating module 21_1 and the error correction module 21_2 may be disposed on one chip or may be mounted on one package/one module together.

According to embodiments, the phase difference calculating module 21_1 may receive the input signal IN_P, which is a baseband signal for the RF signal IN_R, calculate a phase difference for the input signal IN_P, and generate an initial input selection signal INI_SEL for the phase difference data PD and the input signal IN_P. According to embodiments, the input signal IN_P may be in the form of a packet in which a plurality of signals are continuously inputted in time order in one sequence and may include a plurality of symbol information (e.g., a plurality of pieces of symbol information).

According to embodiments, the phase difference data PD may be information corresponding to the phase difference between consecutive input signals IN_P and may include one symbol information (e.g., one piece of symbol information among the plurality of pieces of symbol information). According to embodiments, when the demodulator module 21 operates according to a Bluetooth enhanced data rate (EDR)2 mode, the phase difference data PD may include one of four different types of symbol information. According to embodiments, when the demodulator module 21 operates according to a Bluetooth EDR3 mode, the phase difference data PD may include one of eight different types of symbol information.

According to embodiments, the initial input selection signal INI_SEL may include whether the input signal IN_P is retransmitted (e.g., whether the input signal IN_P represents a retransmitted signal) based on the negative acknowledgment NACK. The error correction module 21_2 may check whether the input signal IN_P for the phase difference data PD is retransmitted based on the initial input selection signal INI_SEL. According to embodiments, the initial input selection signal INI_SEL may be included in a header of a packet for the input signal IN_P.

For example, when the initial input selection signal INI_SEL is logic high, ‘1’, the input signal IN_P may be a signal based on an initial input packet, and when the initial input selection signal INI_SEL is logic low, ‘0’, the input signal IN_P may be based on a packet retransmitted based on the negative acknowledgment NACK.

The error correction module 21_2 may receive the phase difference data PD and the initial input selection signal INI_SEL, perform a soft decision operation based on the phase difference data PD, and perform an error correction operation based on the reliability data generated by the soft decision operation. According to embodiments, the error correction module 21_2 may generate a data block DB for the input signal IN_P and error decision data DE for the input signal IN_P based on the error correction operation.

According to embodiments, the error decision data DE may include whether or not the error correction of the data block DB is performed, and the second communication device 20 may request retransmission by providing the negative acknowledgment NACK to the first communication device 10 based on the error decision data DE.

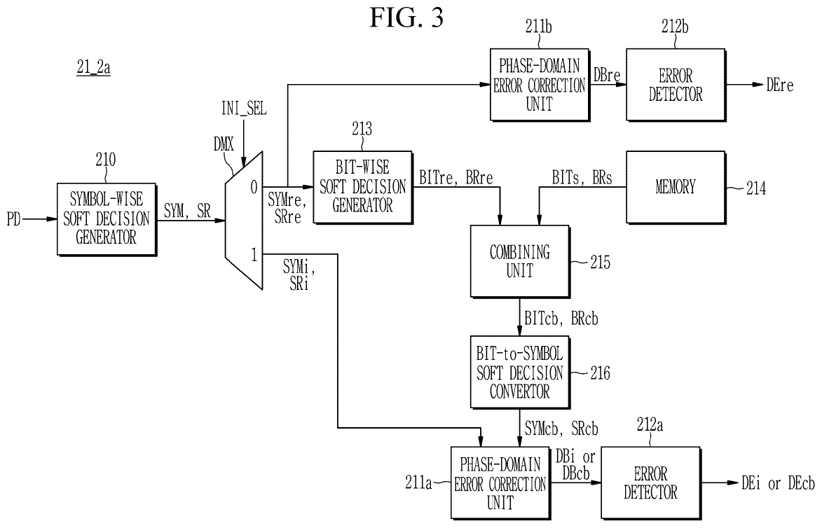

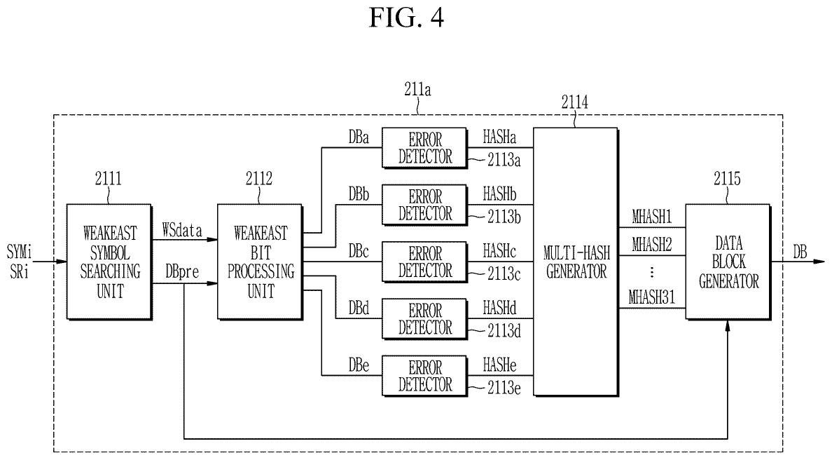

FIG. 3 illustrates a block diagram of an error correction module according to embodiments. FIG. 4 illustrates a phase-domain error correction unit according to embodiments. An error correction module 21_2a of FIG. 3 is an example of (e.g., may be used to implement) the error correction module 21_2 of FIG. 2.

Referring to FIG. 2 to FIG. 4, the error correction module 21_2a may include a symbol-wise soft decision generator 210, first and second phase-domain error correction units 211a and 211b, first and second error detectors 212a and 212b, a bit-wise soft decision generator 213, a memory 214, a combining unit 215, a bit-to-symbol soft decision converter 216, and/or a demultiplexer DMX.

The symbol-wise soft decision generator 210 may perform a soft decision operation based on the phase difference data PD to generate symbol data SYM in units of symbols and symbol reliability data SR for the symbol data SYM.

According to embodiments, the demodulator module 21 may receive the input signal IN_P in a packet unit, and the symbol-wise soft decision generator 210 may receive a plurality of successively received phase difference data PD (e.g., a plurality of successively received pieces of phase difference data PD). The symbol-wise soft decision generator 210 may continuously generate a plurality of symbol data SYM (e.g., a plurality of pieces of symbol data SYM) and symbol reliability data SR (e.g., a plurality of pieces of symbol reliability data SR) based on the plurality of phase difference data PD. According to embodiments, each respective piece of symbol data SYM may be associated with a corresponding piece of symbol reliability data SR).

According to embodiments, when the demodulator module 21 performs demodulation using a quaternary differential phase shift keying (QDPSK) method, the symbol data SYM may include one of four different types of symbols, and one symbol data SYM (e.g., one piece of symbol data SYM) may have a data size of two bits. According to embodiments, when the demodulator module 21 operates according to the Bluetooth EDR2 mode, the demodulator module 21 may perform demodulation using a QDPSK method.

According to embodiments, when the demodulator module 21 performs demodulation using an 8-differential phase shift keying (8DPSK) method, the symbol data SYM may include one of eight different types of symbols, and one symbol data SYM (e.g., one piece of symbol data SYM) may have a data size of 3 bits. According to embodiments, when the demodulator module 21 operates according to the Bluetooth EDR3 mode, the demodulator module 21 may perform demodulation using a 8DPSK method.

The symbol reliability data SR is data indicating a reliability value for a symbol included in the corresponding symbol data SYM, and may be determined based on the phase difference of the phase difference data PD. The symbol reliability data SR may be data having a predetermined (or alternatively, given) number of bits.

According to embodiments, as the reliability value increases, the probability of occurrence of an error in the symbol included in the symbol data SYM may decrease, and as the reliability value decreases, the probability of occurrence of an error in the symbol included in the symbol data SYM may increase.

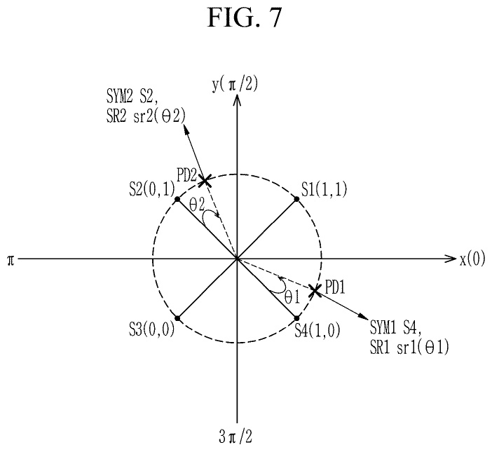

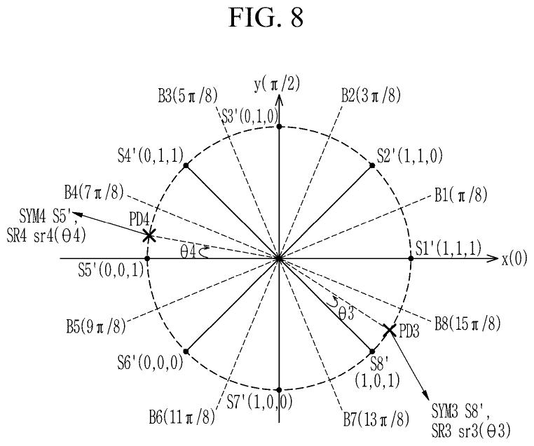

A detailed operation description of the symbol-wise soft decision generator 210 will be described later with reference to FIG. 7 and FIG. 8.

The demultiplexer DMX may operate as a data distributor to receive the symbol data SYM, the symbol reliability data SR and the initial input selection signal INI_SEL, and control a transmission path of the symbol data SYM and the symbol reliability data SR based on the initial input selection signal INI_SEL.

The demultiplexer DMX may check whether the input signal IN_P corresponding to the symbol data SYM is a packet received by a retransmission request based on the initial input selection signal INI_SEL. The demultiplexer DMX may select a transmission path of the symbol data SYM and the symbol reliability data SR according to whether the corresponding input signal IN_P is retransmitted.

For example, when the initial input selection signal INI_SEL is logic high, ‘1’, the demultiplexer DMX may check the input signal IN_P corresponding to the symbol data SYM and the symbol reliability data SR as a signal based on the first input packet, and provide the symbol data SYM and the symbol reliability data SR to the first phase-domain error correction unit 211a as first symbol data SYMi and first symbol reliability data SRi.

For example, when the initial input selection signal INI_SEL is logic low, ‘0’, the demultiplexer DMX may check the input signal IN_P corresponding to the symbol data SYM and the symbol reliability data SR as a signal based on the retransmitted packet, and provide the symbol data SYM and the symbol reliability data SR to the bit-wise soft decision generator 213 and the second phase-domain error correction unit 211b as retransmission symbol data SYMre and retransmission symbol reliability data SRre.

The first phase-domain error correction unit 211a may receive the first symbol data SYMi and the first symbol reliability data SRi, and combining symbol data SYMcb and combining symbol reliability data SRcb, which will be described later, to perform an error correction operation to output first data block DBi or a combining data block DBcb.

The first phase-domain error correction unit 211a may include a weakest symbol searching unit 2111, a weakest bit processing unit 2112, a plurality of error detectors 2113a to 2113e, a multi-hash generator 2114, and/or a data block generator 2115.

According to embodiments, the weakest symbol searching unit 2111 may receive a plurality of initial symbol data SYMi (e.g., a plurality of pieces of initial symbol data SYMi) and a plurality of initial symbol reliability data Sri (e.g., a plurality of pieces of initial symbol reliability data SRi). The weakest symbol searching unit 2111 may generate a data block DBpre and weakest symbol information WSdata before processing based on a plurality of initial symbol data SYMi and a plurality of initial symbol reliability data SRi.

According to embodiments, the data block DBpre before processing may be a data block in which the initial symbol data SYMi continuously inputted to the first phase-domain error correction unit 211a in time order is continuously connected. According to embodiments, the data block DBpre before processing may include a CRC code. According to embodiments, the weak symbol information WSdata may include data disposition information on the weakest initial symbol data in the data block DBpre before processing.

The weakest symbol searching unit 2111 may select a predetermined (or alternatively, given) number of weak initial symbol data (e.g., number of pieces of weak initial symbol data) from among the plurality of initial symbol data SYMi based on the plurality of initial symbol reliability data SRi. The weak initial symbol data may mean symbol data corresponding to reliability data with a smaller reliability value among the plurality of initial symbol reliability data SRi.

The weakest bit processing unit 2112 may each select one weak bit from among the selected weak symbol data among the data blocks DBpre before processing based on the weak symbol information WSdata, and may generate a data block by flipping one bit from the data block DBpre before processing.

Referring to FIG. 4, the weakest bit processing unit 2112 may select weak bits one by one from five weak symbol data (e.g., five pieces of weak symbol data and/or five bits of weak symbol data) based on the weak symbol information WSdata. The weakest bit processing unit 2112 may flip one of different bits among the five selected weak bits to generate a-th to e-th processing data blocks DBa to DBe. According to embodiments, each of the a-th to e-th processing data blocks DBa to DBe may be a data block in which one bit is flipped based on the data block DBpre before processing. In embodiments, the a-th to e-th processing data blocks DBa to DBe may be different data blocks (e.g., may correspond to different blocks among the data blocks DBpre).

In FIG. 4, the number of weak symbols to be selected and the number of weak bits according to the weak symbols are shown as 5, but the technical idea of the present disclosure is not limited thereto, and the number of symbols and bits to be selected may vary in embodiments.

The plurality of error detectors 2113a to 2113e may receive the a-th to e-th processing data blocks DBa to DBe, respectively, and perform error detection of the data block to generate a-th to e-th hashes HASHa to HASHe as results of error detection with respect to the a-th to e-th processing data blocks DBa to DBe. The generated a-th to e-th hashes HASHa to HASHe may be provided to the multi-hash generator 2114.

According to embodiments, the a-th to e-th hashes HASHa to HASHe may have a predetermined (or alternatively, given) number of bits, and the a-th to e-th hashes HASHa to HASHe may include a result of error detection with respect to the a-th to e-th processing data blocks DBa to DBe, respectively.

According to embodiments, the plurality of error detectors 2113a to 2113e are cyclic redundancy checkers, and may perform an error detection operation on data based on divisor data for a predetermined (or alternatively, given) CRC check to generate the a-th to e-th hashes HASHa to HASHe. According to embodiments, each of the a-th to e-th hashes HASHa to HASHe may be a remaining value generated by performing a division operation on each of the a-th to e-th processing data blocks DBa to DBe by predetermined (or alternatively, given) divisor data.

For example, when the a-th processing data block DBa passes an error detection operation (e.g., succeeds) by the a-th error detector 2113a, all bit data in the a-th hash HASHA based on the a-th processing data block DBa may be logic low, ‘0’. Hereinafter, passing the error detection operation may mean that an error in the data block of the error detection target is not detected.

For example, in addition, when an error is detected in the a-th processing data block DBa by the a-th error detector 2113a, the a-th hash HASHA based on the a-th processing data block DBa may include ‘1’, which is logic high.

According to embodiments, the multi-hash generator 2114 may generate a plurality of multi-hashes MHASH1 to MHASH31 by outputting each of the a-th to e-th hashes HASHa to HASHe itself (e.g., separately) or performing an XOR operation on at least some of the a-th to e-th hashes HASHa to HASHe.

According to embodiments, the plurality of multi-hashes MHASH1 to MHASH31 may include a result of error detection for a data block generated by flipping at least some of the selected weak bits. For example, when all bit data of one of the plurality of multi-hashes MHASH1 to MHASH31 is logic low, ‘0’, it may mean that a data block corresponding to the one multi-hash is passed in an error detection operation.

The first phase-domain error correction unit 211a may perform an error detection operation for all cases in which at least some of the weak bits selected by the weak bit processing unit 2112 are flipped through the plurality of multi-hashes MHASH1 to MHASH31.

The data block generator 2115 may generate the first data block DBi by performing an error correction operation on the data block DBpre before processing based on the plurality of multi-hashes MHASH1 to MHASH31.

For example, when all bit data of one of the plurality of multi-hashes MHASH1 to MHASH31 is logic low, ‘0’, the data block generator 2115 may generate the first data block DBi by performing a bit flip operation on the data block DBpre before processing based on the one multi-hash. In addition, when all of the plurality of multi-hashes MHASH1 to MHASH31 include ‘1’, which is logic high, the data block generator 2115 may output the data block DBpre before processing as the initial data block DBi.

In FIG. 4, the first phase-domain error correction unit 211a is only shown to perform an error correction operation based on the initial symbol data SYMi and the initial symbol reliability data SRi, but it is obvious that the components of the first phase-domain error correction unit 211a of FIG. 4 perform an error correction operation based on the combining symbol data SYMcb and the combining symbol reliability data SRcb. According to embodiments, the first phase-domain error correction unit 211a may generate the combining data block DBcb by performing an error correction operation based on the combining symbol data SYMcb and the combining symbol reliability data SRcb.

Referring back to FIG. 3, the first error detector 212a may perform an error detection operation on the initial data block DBi or the combining data block DBcb to output the initial error decision data DEi or the combining error decision data DEcb.

According to embodiments, each of the initial error decision data DEi and the combining error decision data DEcb may have a predetermined (or alternatively, given) number of bits. According to embodiments, each of the initial error decision data DEi (e.g., each piece of the initial error decision data DEi) and the combining error decision data DEcb (e.g., each piece of the combining error decision data DEcb) may include a result of an error detection operation for each of the initial data block DBi and the combining data block DBcb.

According to embodiments, when an error is detected in the initial data block DBi and the combining data block DBcb by the first error detector 212a, the second communication device 20 may provide a negative acknowledgement NACK to the first communication device 10.

The first error detector 212a may correspond to the a-th to e-th error detectors 2113a to 2113e of FIG. 4, and the initial error decision data DEi or the combining error decision data DEcb may correspond to the a-th to e-th hashes HASHA to HASHe of FIG. 4. For better understanding and ease of description, the description of the first error detector 212a is replaced with the description of the a-th to e-th error detectors 2113a to 2113e of FIG. 4.

The second phase-domain error correction unit 211b may receive the retransmission symbol data SYMre and the retransmission symbol reliability data SRre to perform an error correction operation to output the retransmission data block DBre.

The second phase-domain error correction unit 211b may correspond to the first phase-domain error correction unit 211a, the retransmission symbol data SYMre may correspond to the initial symbol data SYMi, the retransmission symbol reliability data SRre may correspond to the initial symbol reliability data SRi, and the retransmission data block DBre may correspond to the initial data block DBi. For better understanding and ease of description, the description of the second phase-domain error correction unit 211b may be replaced with (e.g., may be the same as or similar to) the description of the first phase-domain error correction unit 211a.

The second error detector 212b may perform an error detection operation on the retransmission data block DBre to output the retransmission error decision data DEre.

According to embodiments, the retransmission error decision data DEre may have a predetermined (or alternatively, given) number of bits. According to embodiments, the retransmission error decision data DEre may include a result of an error detection operation on the retransmission data block DBre.

According to embodiments, when an error is detected in the retransmission data block DBre by the second error detector 212b, the second communication device 20 may provide a negative acknowledgment NACK to the first communication device 10.

The second error detector 212b may correspond to the first error detector 212a, and the retransmission error decision data DEre may correspond to the initial error decision data DEi or the combining error decision data DEcb. For better understanding and ease of description, the description of the second error detector 212b may be replaced with (e.g., may be the same as or similar to) the description of the first error detector 212a.

The bit-wise soft decision generator 213 may generate retransmission bit reliability data BRre corresponding to the retransmission bit data BITre and the retransmission bit reliability data SRre in units of bits based on the retransmission symbol data SYMre and the retransmission symbol reliability data SRre. According to embodiments, the retransmission bit reliability data BRre may be a log-likelihood ratio (LLR), but the technical idea of the present disclosure is not limited thereto.

According to embodiments, when the demodulator module 21 performs demodulation in the QDPSK method, the bit-wise soft decision generator 213 may generate two retransmission bit data BITre (e.g., two pieces retransmission bit data BITre) corresponding to different bit digits based on the retransmission symbol data SYMre, and may generate two retransmission bit reliability data BRre (e.g., two pieces of retransmission bit reliability data BRre) corresponding to the two retransmission bit data BITre. One of (e.g., one piece of) the two retransmission bit reliability data BRre may have a reliability value of the same value as (or a similar value to) that of the retransmission symbol reliability data SRre, and the other one thereof may have a maximum (or highest) reliability value.

According to embodiments, when the demodulator module 21 performs demodulation in the 8DPSK method, the bit-wise soft decision generator 213 may generate three retransmission bit data BITre (e.g., three pieces of retransmission bit data BITre) corresponding to different bit digits based on the retransmission symbol data SYMre, and may generate three retransmission bit reliability data BRre (e.g., three pieces of retransmission bit reliability data BRre) corresponding to the three retransmission bit data BITre. One of (e.g., one piece of) the three retransmission bit reliability data BRre may have a reliability value of the same value as (or a similar value to) that of the retransmission symbol reliability data SRre, and the remaining retransmission bit reliability data BRre may have a maximum (or highest) reliability value.

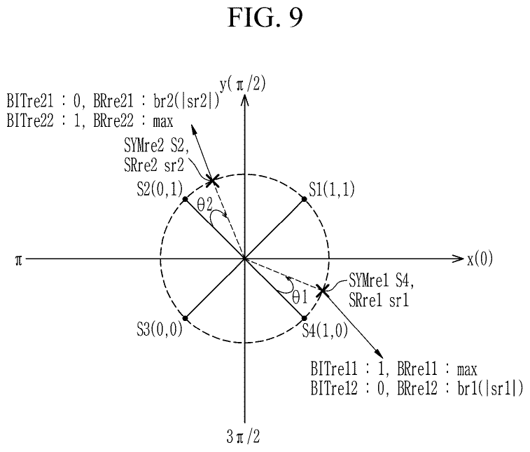

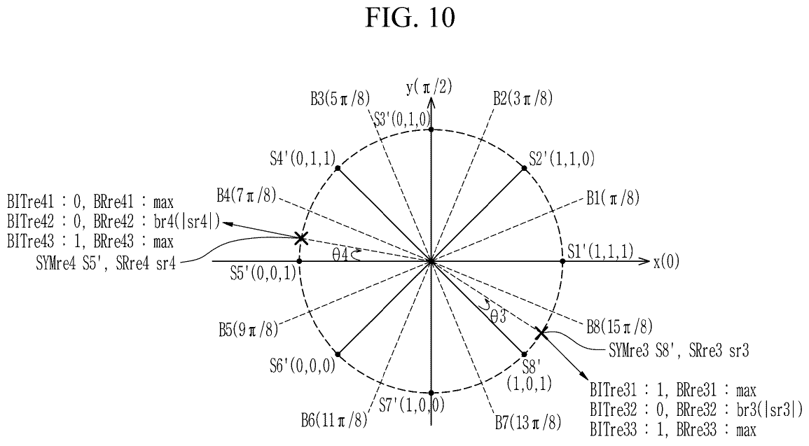

A detailed operation description of the bit-wise soft decision generator 213 will be described later with reference to FIG. 9 and FIG. 10.

The memory 214 may store storage bit data BITs and storage bit reliability data BRs for the storage bit data BITs.

The memory 214 may include a memory element, and according to embodiments, the memory 214 may be a nonvolatile memory such as a DRAM, an SRAM, a NAND flash, and a NOR flash, but is not limited thereto.

In the drawing, the memory 214 is shown to be included in the error correction module 21_2a, but the disposition does not limit the technical idea of the present disclosure. According to embodiments, the memory 214 disposed outside the error correction module 21_2a may store the storage bit data BITs and the storage bit data BITs, and then provide the storage bit data BITs and the storage bit data BITs to the error correction module 21_2a by a read command.

The storage bit data BITs, and the storage bit data BITs may be generated based on phase difference data for a previously received packet. The storage bit data BITs and the storage bit reliability data BRs may correspond to the retransmission bit data BITre and the retransmission bit reliability data BRre, respectively.

According to embodiments, the combining unit 215 may receive retransmission bit data BITre and retransmission bit reliability data BRre, and storage bit data BITs and storage bit reliability data BRs, and perform a combining operation. The combining unit 215 may perform the combining operation to generate combining bit data BITcb and combining bit reliability data BRcb for the combining bit data BITcb.

According to embodiments, the combining unit 215 may perform a chase-combining operation. According to embodiments, the combining unit 215 may change the sign of the reliability values of the retransmission bit reliability data BRre and the stored bit reliability data BRs based on the retransmission bit data BITre and the storage bit data BITS, and may reflect the changed sign to add corresponding reliability values to each other. According to embodiments, the combining unit 215 may generate the combining bit reliability data BRcb by multiplying the added reliability value by a predetermined (or alternatively, given) scaling coefficient.

According to embodiments, a multiplication operation for the predetermined (or alternatively, given) scaling coefficient may be performed in the bit-to-symbol soft decision converter 216, which will be described later. When the bit-symbol soft decision converter 216 performs a multiplication operation on the predetermined (or alternatively, given) scaling coefficient, the bit-to-symbol soft decision converter 216 may perform a multiplication operation on the selected combining bit reliability data to be described later to generate combining symbol reliability data.

For example, when one retransmission bit data BITre is a logic low of ‘0’, the combining unit 215 may change the reliability value of the corresponding retransmission bit reliability data BRre to a negative value and perform a summation operation. If the summed reliability value has a negative value, it changes to a positive value to generate combining bit reliability data BRcb, and the corresponding combining bit data BITcb may be ‘0’, a logic low.

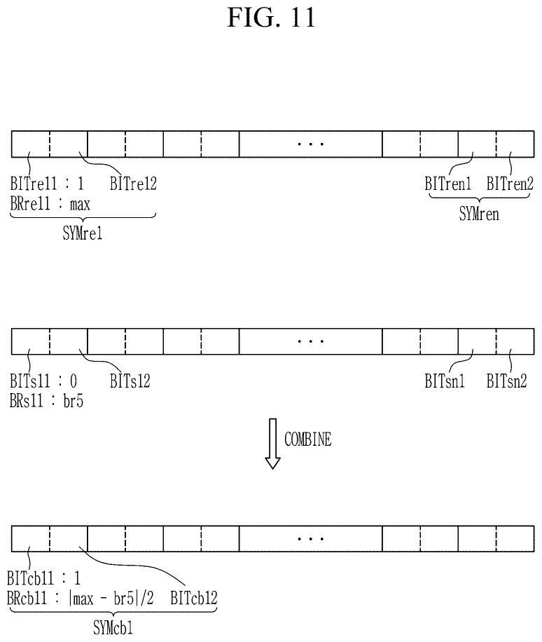

A specific operation of the combining unit 215 will be described later in the description of FIG. 11.

The bit-to-symbol soft decision converter 216 may perform a conversion operation on the combining bit data BITcb and the combining bit reliability data BRcb to generate combining symbol reliability data SRcb corresponding to the combining symbol data SYMcb, and the combining symbol data SYMcb, in symbol units. The bit-to-symbol soft decision converter 216 may provide the generated combining symbol data SYMcb and combining symbol reliability data SRcb to the first phase-domain error correction unit 211a.

For example, when the demodulator module 21 operates according to the Bluetooth EDR2 mode, the combining unit 215 may perform a combining operation on the k-th symbol data (k is an integer equal to or greater than 0), generate (k_1)-th combining bit data and (k_2)-th combining bit data corresponding to different bit digits, and generate (k_1)-th combining bit reliability data corresponding to the (k_1)-th combining bit data and (k_2)-th combining bit reliability data corresponding to the (k_2)-th combining bit data. The bit-to-symbol soft decision converter 216 may generate k-th combining symbol data based on the (k_1)-th combining bit data and the (k_2)-th combining bit data, and may generate k-th combining symbol reliability data by selecting a lower reliability value among the (k_1)-th combining bit reliability data and the (k_2)-th combining bit reliability data. According to embodiments, the bit-to-symbol soft decision converter 216 may generate the k-th combining symbol reliability data by multiplying the combining bit reliability data selected from the (k_1)-th and (k-2)-th combining bit reliability data by a predetermined (or alternatively, given) scaling coefficient.

For example, when the demodulator module 21 operates according to the Bluetooth EDR3 mode, the combining unit 215 may perform a combining operation on k-th symbol data (k is an integer equal to or greater than 0), generate (k_1)-th combining bit data, (k_2)-th combining bit data, and (k_3)-th combining bit data corresponding to different bit digits, and generate (k_1)-th combining bit reliability data corresponding to the (k_1)-th combining bit data, (k_2)-th combining bit reliability data corresponding to the (k_2)-th combining bit data, and (k_3)-th combining bit reliability data corresponding to the (k_3)-th combining bit data. The bit-to-symbol soft decision converter 216 may generate the k-th combining symbol data based on based on the (k_1)-th combining bit data, the (k_2)-th combining bit data, and (k_3)-th combining bit data, and may generate the k-th combining symbol reliability data by selecting a lower reliability value among the (k_1)-th to the (k_3)-th combining bit reliability data. According to embodiments, the bit-to-symbol soft decision converter 216 may generate the k-th combining symbol reliability data by multiplying the combining bit reliability data selected from the (k_1)-th to (k_3)-th combining bit reliability data by a predetermined (or alternatively, given) scaling coefficient.

According to embodiments, the error correction module 21_2a may perform an error detection operation on the retransmission data block DBre generated by performing an error correction operation in parallel on the retransmission packet, and may detect an error in the combining data block DBcb generated by performing an error correction operation after performing the combining operation. According to embodiments, the error correction module 21_2a may perform error correction and error detection on the retransmitted packets in parallel to improve the reception success rate of packet transmission.

According to embodiments, the first phase-domain error correction unit 211a may generate the initial data block DBi by performing an error correction operation on the first input packet, and may generate the combining data block DBcb by performing an error correction operation on the combining symbol data SYMcb and the combining symbol reliability data SRcb on the retransmitted packet. According to embodiments, the error correction module 21_2a includes the first phase-domain error correction unit 211a, thereby improving the reception success rate of packet transmission without adding a separate configuration and without area overhead.

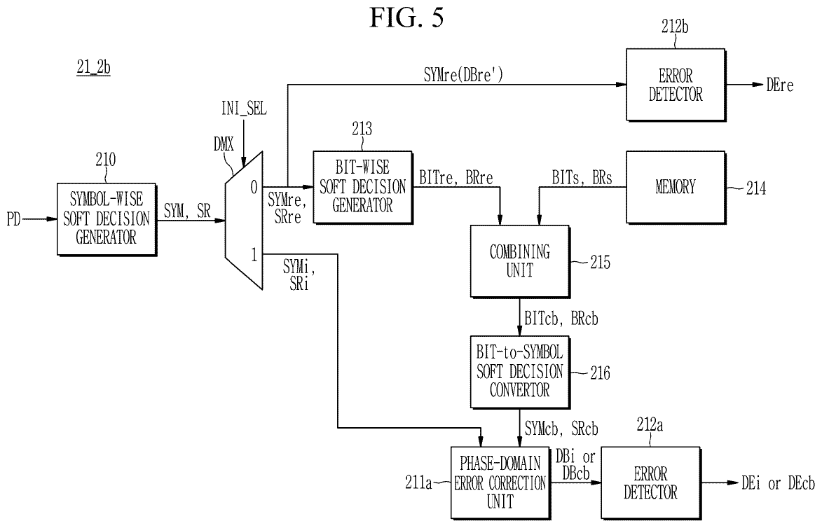

FIG. 5 illustrates a block diagram of an error correction module according to embodiments. An error correction module 21_2b of FIG. 5 is an example of the error correction module 21_2 of FIG. 2. For better understanding and ease of description, the error correction module 21_2b of FIG. 5 will be described focusing on the differences from the error correction module 21_2a of FIG. 3.

The second error detector 212b may receive the retransmission symbol data SYMre from the demultiplexer DMX without a separate error correction operation.

According to embodiments, the second error detector 212b may receive the retransmission symbol data SYMre in the form of a retransmission data block DBre′ that is continuously inputted in time order without performing an error correction operation.

The error correction module 21_2b may detect an error in the retransmitted data block DBre′ in parallel on the retransmitted packet, and may detect an error in the combined data block DBcb generated by performing an error correction operation after performing the combining operation. According to embodiments, the error correction module 21_2b may improve the reception success rate of packet transmission by performing error correction and error detection on retransmission packets in a parallel manner while disposing one phase-domain error correction module (e.g., using only one phase-domain error correction module). Through the disposition of the phase-domain error correction module as described above, the error correction module 21_2b may improve the area overhead and improve the reception success rate of packet transmission.

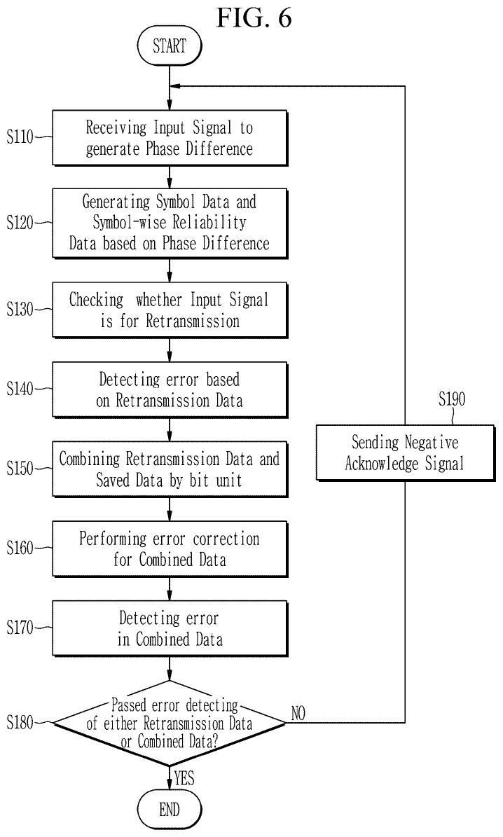

FIG. 6 illustrates a flowchart of an operating method of a demodulator module according to embodiments. FIG. 7 to FIG. 12 are drawings for describing an operating method of a demodulator module according to embodiments. Specifically, FIG. 6 illustrates a demodulation operation method of the demodulator module 21 for a retransmission packet.

Referring to FIG. 2 to FIG. 6, the phase difference calculating module 21_1 receives a plurality of input signals IN_P to generate phase difference data PD between the plurality of input signals IN_P (S110).

The phase difference calculating module 21_1 may generate the phase difference data PD by receiving the plurality of input signals IN_P that are continuously inputted in time order in one sequence. The phase difference data PD may be information corresponding to the phase difference between the consecutive input signals IN_P.

The symbol-wise soft decision generator 210 may perform a soft decision operation based on the phase difference data PD to generate symbol data SYM of the symbol unit and symbol reliability data SR, which is reliability data for the symbol data (SYM) (S120).

When the demodulator module 21 performs a DPSK demodulation operation, the symbol-wise soft decision generator 210 may perform a soft decision operation based on the phase difference data PD.

FIG. 7 illustrates an operation example of the symbol-wise soft decision generator 210 in a Bluetooth EDR2 mode. Referring additionally to FIG. 7, while operating in the Bluetooth EDR2 mode, the symbol-wise soft decision generator 210 may perform soft decision on the x-axis and y-axis as decision boundaries. A positive portion of the x-axis may mean a phase difference value of 0, and a negative portion of the x-axis may mean a phase difference value of x. A positive portion of the y-axis may mean a phase difference value of π/2, and a negative portion of the y-axis may mean a phase difference value of 3π/2. According to embodiments, the symbol-wise soft decision generator 210 may determine one of the first to fourth symbols S1 to S4 different from each other as symbol data based on the phase difference value of the phase difference data PD.

For example, when the phase difference value of the phase difference data PD is between the positive portion of the x-axis and the positive portion of the y-axis where the first symbol S1 is positioned, symbol data generated based on the phase difference data PD may include information on the first symbol S1.

According to embodiments, the symbol-wise soft decision generator 210 may compare the phase difference values of the first to fourth symbols S1 to S4 with the phase difference value of the phase difference data PD to generate symbol reliability data. Hereinafter, referring to FIG. 7 as an example, the first symbol S1 may have a phase difference value of π/4, and may include information of ‘11’ having a size of 2 bits. The second symbol S2 may have a phase difference value of 3π/4, and may include information of ‘01’ having a size of 2 bits. The third symbol S3 may have a phase difference value of 5π/4, and may include information of ‘00’ having a size of 2 bits. The fourth symbol S4 may have a phase difference value of 7π/4, and may include information of ‘10’ having a size of 2 bits.

According to embodiments, as the phase difference value of the phase difference data PD approaches the phase difference value of each of the first to fourth symbols S1 to S4, the reliability value of the symbol reliability data may increase, and as the phase difference value of the phase difference data PD approaches the x-axis and y-axis, which are decision boundaries, the reliability value of the symbol reliability data may decrease.

The symbol-wise soft decision generator 210 may perform a soft decision operation on the input first and second phase difference data PD1 and PD2 to generate symbol reliability data SR1 and SR2 for the first and second symbol data SYM1 and SYM2.

When the phase difference value of the first phase difference data PD1 is between the positive portion of the x-axis and the negative portion of the y-axis, the symbol-wise soft decision generator 210 may determine the first symbol data SYM1 for the first phase difference data PD1 as the fourth symbol S4. The symbol-wise soft decision generator 210 may generate first symbol reliability data SR1 having an sr1 value based on θ1, which is a value between the phase difference value of the first phase difference data PD1 and the phase difference value of the fourth symbol S4. According to embodiments, the θ1 may be within −π/4 to π/4, and the θ1 may have a positive value and correspondingly, the sr1 may have a positive value according to the example of FIG. 7.

When the phase difference value of the second phase difference data PD2 is between the negative portion of the x-axis and the positive portion of the y-axis, the symbol-wise soft decision generator 210 may determine the second symbol data SYM2 for the second phase difference data PD2 as the second symbol S2. The symbol-wise soft decision generator 210 may generate second symbol reliability data SR2 having an sr2 value based on θ2, which is a value between the phase difference value of the second phase difference data PD2 and the phase difference value of the second symbol S2. According to embodiments, the θ2 may be within −π/4 to π/4, and the θ2 may have a negative value and correspondingly, the sr2 may have a negative value according to the example of FIG. 7.

In FIG. 7, the phase difference values of the first to fourth symbols S1 to S4 and the determination boundary values are specified and described as predetermined (or alternatively, given) values, but they are examples for description, and the technical idea of the present disclosure is not limited thereto.

FIG. 8 illustrates an operation example of the symbol-wise soft decision generator 210 in a Bluetooth EDR3 mode. Referring additionally to FIG. 8, the symbol-wise soft decision generator 210 may perform the soft decision based on the first to eighth decision boundaries B1 to B8. According to embodiments, the first decision boundary B1 may mean a phase difference value of π/8, the second decision boundary B2 may mean a phase difference value of 3π/8, the third decision boundary B3 may mean a phase difference value of 5π/8, the fourth decision boundary B4 may mean a phase difference value of 7π/8, the fifth decision boundary B5 may mean a phase difference value of 9π/8, the sixth decision boundary B6 may mean a phase difference value of 11π/8, the seventh decision boundary B7 may mean a phase difference value of 13π/8, and the eighth decision boundary B8 may mean a phase difference value of 15π/8. According to embodiments, the symbol-wise soft decision generator 210 may determine one of the first to eighth symbols S1′ to S8′ different from each other as symbol data based on the phase difference value of the phase difference data PD.

For example, when the phase difference value of the phase difference data PD is between the first decision boundary B1 and the eighth decision boundary B8 where the first symbol S1′ is positioned, the symbol data generated based on the phase difference data PD may include information on the first symbol S1′.

According to embodiments, the symbol-wise soft decision generator 210 may compare the phase difference values of the first to eighth symbols S1′ to S8′ and the phase difference value of the phase difference data PD to generate symbol reliability data. Hereinafter, referring to FIG. 8 as an example, the first symbol S1′ may have a phase difference value of 0 and may include information of ‘111’ having a size of 3 bits. The second symbol S2′ may have a phase difference value of π/4, and may include information of ‘110’ having a size of 3 bits. The third symbol S3′ may have a phase difference value of π/2 and may include information of ‘010’ having a size of 3-bits. The fourth symbol S4′ may have a phase difference value of 3π/4, and may include information of ‘011’ having a size of 3 bits. The fifth symbol S5′ may have a phase difference value of x, and may include information of ‘001’ having a size of 3 bits. According to embodiments, the sixth symbol S6′ may have a phase difference value of 5π/4, and may include information of ‘000’ having a size of 3 bits. The seventh symbol S7′ may have a phase difference value of 3π/2, and may include information of ‘100’ having a size of 3 bits. The eighth symbol S8′ may have a phase difference value of 7π/4, and may include information of ‘101’ having a size of 3 bits.

According to embodiments, as the phase difference value of the phase difference data PD approaches the phase difference value of each of the first to eighth symbols S1′ to S8′, the reliability value of the symbol reliability data may increase, and as the phase difference value of the phase difference data PD approaches the first to eighth decision boundaries B1-B8, which are decision boundaries, the reliability value of the symbol reliability data may decrease.

The symbol-wise soft decision generator 210 may perform a soft decision operation on the input third and fourth phase difference data PD3 and PD4 to generate symbol reliability data SR3 and SR4 for the third and fourth symbol data SYM3 and SYM4.

When the phase difference value of the third phase difference data PD3 is between the sixth decision boundary B6 and the seventh decision boundary B7, the symbol-wise soft decision generator 210 may determine the third symbol data SYM3 for the third phase difference data PD3 as the eighth symbol S8′. The symbol-wise soft decision generator 210 may generate third symbol reliability data SR3 having an sr3 value based on θ3, which is a value between the phase difference value of the third phase difference data PD3 and the phase difference value of the eighth symbol S8′. According to embodiments, the θ3 may be within −π/8 to π/8, and the θ3 may have a positive value and correspondingly, the sr3 may have a positive value according to the example of FIG. 8.

The phase difference value of the fourth phase difference data PD4 is between the third decision boundary B3 and the fourth decision boundary B4, so that the symbol-wise soft decision generator 210 may determine the fourth symbol data SYM4 for the fourth phase difference data PD4 as the fifth symbol S5′. The symbol-wise soft decision generator 210 may generate fourth symbol reliability data SR4 having an sr4 value based on θ4, which is a value between the phase difference value of the fourth phase difference data PD4 and the phase difference value of the fifth symbol S5′. According to embodiments, the θ4 may be within −π/8 to π/8, and the θ4 may have a negative value and correspondingly, the sr4 may have a negative value according to the example of FIG. 8.

In FIG. 8, the phase difference values of the first to eighth symbols S1′ to S8′ and the values of the first to eighth decision boundaries B1 to B8 are specified and described as predetermined (or alternatively, given) values, but they are examples for description, and the technical idea of the present disclosure is not limited thereto.

Referring back to FIG. 6, the demultiplexer DMX checks whether the input signal IN_P is retransmitted based on the initial input selection signal INI_SEL (S130).

The demultiplexer DMX may determine a transmission path for the generated symbol data SYM and symbol reliability data SR according to the checking of whether the input signal IN_P is retransmitted.

When the input signal IN_P is based on the initially input packet, the demultiplexer DMX may provide the generated symbol data SYM and symbol reliability data SR to the first phase-domain error correction unit 211a as the initial symbol data SYMi and the initial symbol reliability data SRi.

If the input signal IN_P is based on the retransmitted packet, the demultiplexer DMX may provide the generated symbol data SYM and symbol reliability data (SR) in parallel. In the error correction module 21_2a of FIG. 3, the demultiplexer DMX may provide the generated symbol data SYM and symbol reliability data SR to the bit-wise soft decision generator 213 and the second phase-domain error correction unit 211b in parallel as the retransmission symbol data SYMre and retransmission symbol reliability data SRre. In the error correction module 21_2b of FIG. 5, the demultiplexer DMX may provide the generated symbol data SYM and symbol reliability data SR to the bit-wise soft decision generator 213 and the second error detector 212b in parallel as the retransmission symbol data SYMre and retransmission symbol reliability data SRre.

The second error detector 212b detects an error in the retransmission data blocks DBre and DBre′ (S140).

In the error correction module 21_2a of FIG. 3, the retransmission data block DBre inputted to the second error detector 212b may be a data block generated by the second phase-domain error correction unit 211b performing an error correction operation based on the retransmission symbol data SYMre and the retransmission symbol reliability data SRre.

In the error correction module 21_2b of FIG. 5, the retransmission data block DBre′ inputted to the second error detector 212b may be a data block generated by continuously inputting the retransmission symbol data SYMre in time order without performing an error correction operation.

The second error detector 212b may receive the retransmission data blocks DBre and DBre′ and perform an error detection operation to generate the retransmission error decision data DEre as a result of error detection on the retransmission data blocks DBre and DBre′.

According to embodiments, the retransmission error decision data DEre may have a predetermined (or alternatively, given) number of bits, and the retransmission error decision data DEre may include a result of error detection on the retransmission data blocks DBre and DBre′.

According to embodiments, the second error detector 212b may perform error detection based on divisor data for a predetermined (or alternatively, given) CRC check to generate retransmission error decision data DEre. According to embodiments, the retransmission error decision data DEre may be a remaining value generated by performing a division operation on the retransmission data blocks DBre and DBre′ by predetermined (or alternatively, given) divisor data.

For example, when the error detection operation by the second error detector 212b passes for the retransmission data blocks DBre and DBre′, all bit data in the retransmission error decision data DEre may be ‘0’, which is logic low. In addition, when an error is detected in the retransmission data blocks DBre and DBre′ by the second error detector 212b, the retransmission error decision data DEre may include ‘1’, which is logic high.

The combining unit 215 receives retransmission bit data BITre, retransmission bit reliability data BRre, storage bit data BITs, and storage bit reliability data BRs, and performs a combining operation in bit units (S150).

Before the combining operation of the combining unit 215, the bit-wise soft decision generator 213 may generate retransmission bit data BITre and retransmission bit reliability data BRre in bit units based on the retransmission symbol data SYMre and the retransmission symbol reliability data SRre.

FIG. 9 illustrates an operation example of the bit-wise soft decision generator 213 in a Bluetooth EDR2 mode. Referring additionally to FIG. 9, while operating in the Bluetooth EDR2 mode, the bit-wise soft decision generator 213 may perform the soft decision in bit units based on the phase difference values of the first to fourth symbols S1 to S4. The phase difference values of the first to fourth symbols S1 to S4 may correspond to the phase difference values of the first to fourth symbols S1 to S4 of FIG. 7.

Hereinafter, the operation of the bit-wise soft decision generator 213 will be described using the first retransmission symbol data SYMre1 and the first retransmission symbol reliability data SRre1 as examples. The first retransmission symbol data SYMre1 may be the fourth symbol S4, the first retransmission symbol reliability data SR1 may be sr1, and the value of the sr1 may correspond to θ1.

The bit-wise soft decision generator 213 may generate (1_1)-th retransmission bit data BITre11 having ‘1’ and (1_2)-th retransmission bit data BITre12 having ‘0’ based on the fourth symbol S4.

The bit-wise soft decision generator 213 may generate (1_1)-th retransmission bit reliability data BRre11 with a predetermined (or alternatively, given) maximum (or highest) reliability value, max, and (1_2)-th retransmission bit reliability data BRre12 with a size of the sr1, based on the fourth symbol S4 and the sr1. The size of the sr1 may be greater than 0 and less than or equal to the max.

Based on the fourth symbol S4 and the sign of the sr1, the bit-wise soft decision generator 213 may select one corresponding to the weak bit among the (1_1)-th retransmission bit reliability data BRre11 and the (1_2)-th retransmission bit reliability data BRre12 to assign the reliability value to br1, which is the absolute value of the sr1, and may select the other one thereof to assign the reliability value to the max.

Since the sign of the sr1 becomes a positive value corresponding to θ1 that is 0 or more, the bit-wise soft decision generator 213 may assign the max to the (1_1) retransmission bit reliability data BRre11 corresponding to the (1_1)-th retransmission bit data BITre11, which is a relatively strong bit, based on the fourth symbol S4 and the first symbol S1 adjacent to the fourth symbol S4 in the positive direction.

The bit-wise soft decision generator 213 may assign br1 to the (1_2)-th retransmission bit reliability data BRre12 corresponding to the (1_2)-th retransmission bit data BITre 12, which is a relatively weak bit.

Hereinafter, the operation of the bit-wise soft decision generator 213 will be described using the second retransmission symbol data SYMre2 and the second retransmission symbol reliability data SRre2 as examples. The second retransmission symbol data SYMre2 may be the second symbol S2, the second retransmission symbol reliability data SR2 may be sr2, and the value of the sr2 may correspond to θ2.

The bit-wise soft decision generator 213 may generate (2_1)-th retransmission bit data BITre21 having ‘0’ and (2_2)-th retransmission bit data BITre22 having ‘1’ based on the second symbol S2.

Based on the second symbol S2 and the sr2, the bi-wise soft decision generator 213 may generate (2_1)-the retransmission bit reliability data BRre21 having a size of sr2 and (2_2)-th retransmission bit reliability data BRre22 having the max as a predetermined (or alternatively, given) maximum (or highest) reliability value. The size of the sr2 may be greater than 0 and less than or equal to the max.

Based on the second symbol S2 and the sign of the sr2, the bit-wise soft decision generator 213 may select one corresponding to the weak bit among the (2_1)-th retransmission bit reliability data BRre21 and the (2_2)-th retransmission bit reliability data BRre22 to assign the reliability value to br2, which is the absolute value of the sr2, and may select the other one thereof to assign the reliability value to the max.

Since the sign of the sr2 becomes a negative value corresponding to θ2 that is 0 or less, the bit-wise soft decision generator 213 may assign the max to the (2_2) retransmission bit reliability data BRre22 corresponding to the (2_2)-th retransmission bit data BITre22, which is a relatively strong bit, based on the second symbol S2 and the first symbol S1 adjacent to the second symbol S2 in the negative direction.

The bit-wise soft decision generator 213 may assign br2 to the (2_1)-th retransmission bit reliability data BRre21 corresponding to the (2_1)-th retransmission bit data BITre21, which is a relatively weak bit.

In FIG. 9, the phase difference values of the first to fourth symbols S1 to S4 and the determination boundary values are specified and described as predetermined (or alternatively, given) values, but they are examples for description, and the technical idea of the present disclosure is not limited thereto.

FIG. 10 illustrates an operation example of the bit-wise soft decision generator 213 in a Bluetooth EDR3 mode. Referring additionally to FIG. 10, while operating in the Bluetooth EDR3 mode, the bit-wise soft decision generator 213 may perform the soft decision in bit units based on the phase difference values of the first to eighth symbol S1′ to S8′. The phase difference values of the first to eighth symbol S1′ to S8′ may correspond to the phase difference values of the first to eighth symbol S1′ to S8′ of FIG. 8.

Hereinafter, the operation of the bit-wise soft decision generator 213 will be described using the third retransmission symbol data SYMre3 and the third retransmission symbol reliability data SRre3 as examples. The first retransmission symbol data SYMre3 may be the fourth symbol S8′, the first retransmission symbol reliability data SR3 may be sr3, and the value of the sr3 may correspond to θ3.

Based on the eighth symbol S8′, the bit-wise soft decision generator 213 may generate (3_1)-th retransmission bit data BITre31 having ‘1’, (3_2)-th retransmission bit data BITre32 having ‘0’, and (3_3)-th retransmission bit data BITre33 having ‘1’.

Based on the eighth symbol S8′ and the sr3, the bit-wise soft decision generator 213 may generate (3_1)-th retransmission bit reliability data BRre31 having the max as a predetermined (or alternatively, given) maximum (or highest) reliability value, (3_2)-th retransmission bit reliability data BRre32 having a size of the sr3, and (3_3)-th retransmission bit reliability data BRre33 having the max as a predetermined (or alternatively, given) maximum (or highest) reliability value. The size of the sr3 may be greater than 0 and less than or equal to the max.

Based on the eighth symbol S8′ and the sign of the sr3, the bit-wise soft decision generator 213 may select one corresponding to the weak bit among the (3_1)-th to (3_3)-th retransmission bit reliability data BRre31 to BRre33 to assign the reliability value to br3, which is the absolute value of the sr3, and may select the remainder thereof to assign the reliability value to the max.

Since the sign of sr3 becomes a positive value corresponding to θ3 that is 0 or more, the bit-wise soft decision generator 213 may assign the max to the (3_1)-th retransmission bit reliability data BRre31 and the (3_3)-th retransmission bit reliability data BRre33 corresponding to the (3_1)-th retransmission bit data BITre31 and the (3_3)-th retransmission bit data BITre33, which are relatively strong bits, based on the eighth symbol S8′ and the first symbol S1′ that is adjacent to the eighth symbol S8′ in the positive direction.

The bit-wise soft decision generator 213 may assign br3 to the (3_2)-th retransmission bit reliability data BRre32 corresponding to the (3_2)-th retransmission bit data BITre32, which is a relatively weak bit.

Hereinafter, the operation of the bit-wise soft decision generator 213 will be described using the fourth retransmission symbol data SYMre4 and the fourth retransmission symbol reliability data SRre4 as examples. The fourth retransmission symbol data SYMre4 may be the fifth symbol S5′, the fourth retransmission symbol reliability data SR4 may be sr4, and the value of the sr3 may correspond to θ4.

Based on the fifth symbol S5′, the bit-wise soft decision generator 213 may generate (4_1)-th retransmission bit data BITre41 having ‘0’, (4_2)-th retransmission bit data BITre42 having ‘0’, and (4_3)-th retransmission bit data BITre43 having ‘1’.

Based on the fifth symbol S5′ and the sr4, the bit-wise soft decision generator 213 may generate (4_1)-th retransmission bit reliability data BRre41 having the max as a predetermined (or alternatively, given) maximum (or highest) reliability value, (4_2)-th retransmission bit reliability data BRre42 having a size of the sr4, and (4_3)-th retransmission bit reliability data BRre43 having the max as a predetermined (or alternatively, given) maximum (or highest) reliability value. The size of the sr4 may be greater than 0 and less than or equal to the max.

Based on the fifth symbol S5′ and the sign of the sr4, the bit-wise soft decision generator 213 may select one corresponding to the weak bit among the (4_1)-th to (4_3)-th retransmission bit reliability data BRre41 to BRre43 to assign the reliability value to br4, which is the absolute value of the sr4, and may select the remainder thereof to assign the reliability value to the max.

Since the sign of sr4 becomes a negative value corresponding to θ4 that is 0 or less, the bit-wise soft decision generator 213 may assign the max to the (4_1)-th retransmission bit reliability data BRre41 and the (4_3)-th retransmission bit reliability data BRre43 corresponding to the (4_1)-th retransmission bit data BITre41 and the (4_3)-th retransmission bit data BITre43, which are relatively strong bits, based on the fifth symbol S5′ and the fourth symbol S4′ that is adjacent to the fifth symbol S5′ in the negative direction.

The bit-wise soft decision generator 213 may assign br4 to the (4_2)-th retransmission bit reliability data BRre42 corresponding to the (4_2)-th retransmission bit data BITre42, which is a relatively weak bit.

In FIG. 10, the phase difference values of the first to eighth symbols S1′ to S8′ and the values of the first to eighth decision boundaries B1 to B8 are specified and described as predetermined (or alternatively, given) values, but they are examples for description, and the technical idea of the present disclosure is not limited thereto.

Referring back to FIG. 6, the combining unit 215 may perform a combining operation on the retransmission bit data BITre and the retransmission bit reliability data BRre generated based on the retransmission symbol data SYMre and the retransmission symbol reliability data SRre, and the storage bit data BITs and the storage bit reliability data BRs corresponding thereto to generate the combining bit data BITcb and the combining bit reliability data BRcb (S150).

FIG. 11 illustrates an operation example of the combining unit 215. FIG. 11 illustrates the operation of the combining unit 215 operating in the Bluetooth EDR2, but the technical idea of the present disclosure is not limited thereto, and it is obvious that the description of FIG. 11 may also be applied to the operation of the combining unit 215 operating in the Bluetooth EDR3.

Referring additionally to FIG. 11, the combining unit 215 may receive a plurality of retransmission bit data BITre11 to BITren2 and a plurality of retransmission bit reliability data corresponding thereto from the bit-wise soft decision generator 213, and receive a plurality of storage bit data BITs11 to BITsn2 and a plurality of storage bit reliability data corresponding thereto from the memory 214.

According to embodiments, two retransmission bit data (e.g., two pieces, or bits, of retransmission bit data) disposed consecutively may correspond to one retransmission symbol data. For example, the (1_1)-th and (1_2)-th retransmission bit data BITre11 and BITre12 may correspond to the first retransmission symbol data SYMre1, and the (n_1)-th and (n_2)-th retransmission bit data BITren1 and BITren2 may correspond to the first retransmission symbol data SYMren.

The combining unit 215 may perform a chase combining operation on the retransmission bit data BITre, the storage bit data BITs corresponding to the retransmission bit reliability data BRre, and the storage bit reliability data BRs. Hereinafter, the operation of the combining unit 215 will be described using the (1_1)-th retransmission bit data BITre11, the (1_1)-th retransmission bit reliability data BRre11 and the (1_1)-th storage bit data BITs11, and the (1_1)-th storage bit reliability data BRs11 as examples.

The (1_1)-th retransmission bit data BITre11 may have ‘l’, and the corresponding (1_1)-th storage bit data BITs11 may have ‘0’. The (1_1)-th retransmission bit reliability data BRre11 for the (1_1)-th retransmission bit data BITre11 may have a reliability value of max, and the (1_1)-th storage bit reliability data BRs11 for the corresponding (1_1)-th storage bit data BITs11 may have a reliability value of br5. The br5 may be greater than 0 and less than or equal to the max.

The combining unit 215 may change the sign of the (1_1)-th storage bit reliability data BRs11 for the (1_1)-th storage bit data BITs11 having ‘0’. The combining unit 215 may change the sign of the (1_1)-th storage bit reliability data BRs11 and then add the (1_1)-th storage bit reliability data BRs11 whose sign has been changed and the (1_1)-th retransmission bit reliability data BRre11. The combining unit 215 may multiply the added value by a predetermined (or alternatively, given) scaling coefficient, and generate the size of the multiplied value as the (1_1)-th combining bit reliability data BRcb11. Referring to FIG. 11, the (1_1)-th combining bit reliability data BRcb11 may have an absolute value of (max-br5)/2.

When the value multiplied by the predetermined (or alternatively, given) scaling coefficient is a positive value, the combining unit 215 may generate (1_1)-the combining bit data BITcb11 having ‘1’. Referring to FIG. 11 as an example, the (1_1)-th combining bit data BITcb11 may have ‘1’. If the value multiplied by the predetermined (or alternatively, given) scaling coefficient is a negative value, the combining unit 215 may generate (1_1)-th combining bit data BITcb11 having ‘0’.

After the operation of the combining unit 215, the bit-to-symbol soft decision converter 216 may perform a conversion operation on the combining bit data BITcb and the combining bit reliability data BRcb to generate combining symbol reliability data SRcb corresponding to the combining symbol data SYMcb, and the combining symbol data SYMcb, in symbol units.

The bit-to-symbol soft decision converter 216 may generate the first combining symbol data SYMcb1 based on the (1_1)-th combining bit data BITcb11 and the (1_2)-th combining bit data BITcb 12, and may generate the first combining symbol reliability data by selecting a lower reliability value among the (1_1)-th combining bit reliability data BRcb12 and the (1_2)-th combining bit reliability data for the (1_2)-th combining bit data BITcb 12.

Referring back to FIG. 6, the first phase-domain error correction unit 211a receives the combining symbol data SYMcb and the combining symbol reliability data SRcb to perform an error correction operation to generate a combining data block DBcb (S160).

The first phase-domain error correction unit 211a may generate a data block DBpre and weak symbol information WSdata before processing based on the combining symbol data SYMcb and the combining symbol reliability data SRcb.

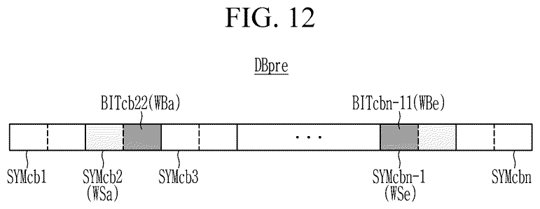

FIG. 12 illustrates an operation example of the first phase-domain error correction unit 211a. FIG. 12 illustrates the operation of the first phase-domain error correction unit 211a operating in Bluetooth EDR2, but the present disclosure is not limited thereto, and it is obvious that the description of FIG. 12 may also be applied to the operation of the first phase-domain error correction unit 211a operating in Bluetooth EDR3.

Referring additionally to FIG. 12, the first phase-domain error correction unit 211a may generate a data block DBpre before processing based on a plurality of combining symbol data SYMcb1 to SYMcbn) that are continuously inputted.

The first phase-domain error correction unit 211a may generate weak symbol information WSdata for the data block DBpre before processing based on the plurality of combining symbol data SYMcb1 to SYMcbn and combining symbol reliability data corresponding to the plurality of combining symbol data SYMcb1 to SYMcbn.

Referring to FIG. 12 as an example, the weak symbol information WSdata may include information on the a-th to e-th weak symbols WSa to WSe in the data block DBpre before processing. For example, the first phase-domain error correction unit 211a may select the second combining symbol data SYMcb2 as an a-th weak symbol WSa, and the first phase-domain error correction unit 211a may select the (n-1)-th combining symbol data SYMcbn-1 as an e-th weak symbol WSe.

The first phase-domain error correction unit 211a may select weak bits from the selected a-th to e-th weak symbols WSa to WSe. For example, the first phase-domain error correction unit 211a may select the (2_2)-th combining bit data BITcb22 as the a-th weak bit WBa in the second combining symbol data SYMcb2, and the first phase-domain error correction unit 211a may select the (n-1_1)-th combining bit data BITcbn-11 as the e-th weak bit WBe in the (n-1)-th combining symbol data SYMcbn-1.

The first phase-domain error correction unit 211a may flip one of the selected a-th to e-th weak bits WBa to WBe to generate the a-th to e-th processing data blocks DBa to DBe. Referring to FIG. 12 as an example, the first phase-domain error correction unit 211a may generate an a-th processing data block DBa by flipping the (2_2)-th combining bit data BITcb22 in the data block DBpre before processing.

The first phase-domain error correction unit 211a may perform error detection on the a-th to e-th processing data blocks DBa to DBe, respectively, to generate a-th to e-th hashes HASHA to HASHe as results of error detection on the a-th to e-th processing data blocks DBa to DBe.

According to embodiments, the first phase-domain error correction unit 211a may generate a plurality of multi-hashes MHASH1 to MHASH31 by generating each of the a-th to e-th hashes HASHa to HASHe itself or performing an XOR operation on at least some of the a-th to e-th hashes HASHa to HASHe.

Each of the plurality of multi-hash MHASH1-MHASH31 may include a result of error detection on a data block generated by flipping at least some of the selected a-th to e-th weak symbols WSa to WSe. For example, when all bit data of one of the plurality of multi-hashes MHASH1 to MHASH31 is logic low, ‘0’, it may mean that a data block corresponding to the one multi-hash is passed in an error detection operation.

The first phase-domain error correction unit 211a may perform an error detection operation for all cases in which at least some of the weak bits selected by the weak bit processing unit 2112 are flipped through the plurality of multi-hashes MHASH1 to MHASH31.

The first phase-domain error correction unit 211a may generate a combining data block DBcb by performing an error correction operation of flipping some bit data of the data block DBpre before processing based on the plurality of multi-hashes MHASH1 to MHASH31. When the error correction operation cannot be (e.g., is unable to be) performed, the first phase-domain error correction unit 211a may generate the data block DBpre itself before processing as the combining data block DBcb.

The first error detector 212a detects an error of the combining data block DBcb (S170).

The first error detector 212a may receive the combining data block DBcb and perform error detection to generate combining error decision data DEcb as a result of error detection for the combining data block DBcb.

According to embodiments, the combining error decision data DEcb may have a predetermined (or alternatively, given) number of bits, and the combining error decision data DEcb may include a result of error detection for the combining data block DBcb.

According to embodiments, the first error detector 212a may perform an error detection operation based on divisor data for a predetermined (or alternatively, given) CRC check to generate combining error decision data DEcb. According to embodiments, the combining error decision data DEcb may be a remaining value generated by performing a division operation on the combining data block DBcb by predetermined (or alternatively, given) divisor data.

For example, when the combining data block DBcb passes the error detection operation by the first error detector 212a, all bit data in the combining error decision data DEcb may be ‘0’, which is logic low. In addition, if the combining data block DBcb fails the error detection operation by the error detector 212b, the combining error decision data DEcb may include ‘1’, which is logic high.

In FIG. 6, it is illustrated that operation S140 precedes the operations S150 to S170, but the order is for ease of description, and the technical idea of the present disclosure is not limited thereto. According to embodiments, the operations S150 to S170 may be performed prior to or together with the operation S140.

The demodulator module 21 checks whether at least one of the retransmission data blocks DBre and DBre′ and the combining data block DBcb passes the error detection operation (e.g., the operation succeeds) based on the retransmission error decision data DEre and the combining error decision data DEcb (S180).

When the retransmission error decision data DEre and the combining error decision data DEcb include error detection of the retransmission data blocks DBre and DBre′ and the combining data block DBcb, the second communication device 20 provides a negative acknowledgment NACK to the first communication device 10 to request retransmission (S190). According to embodiments, in response to determining that at least one of the retransmission data blocks DBre and DBre′ and the combining data block DBcb passes the error detection operation (e.g., the operation succeeds) based on the retransmission error decision data DEre and the combining error decision data DEcb (S180), the second communication device 20 may perform one or more further operation(s) based on the received packet. For example, the one or more further operation(s) may include one or more of providing packet data from the packet to an application executing on the second communication device 20 (e.g., for performing a service based on the packet data), storing the packet data, sending a response signal to the first communication device 10 based on the packet data, etc.

After providing the negative acknowledgment NACK, the second communication device 20 may repeat the operations of S110 to S180.

According to embodiments, the error correction modules 21_2a and 21_2b may perform the operation S140 and the operations S150 to S170 in a parallel manner for the retransmission packet to improve the reception success rate of the packet transmission.

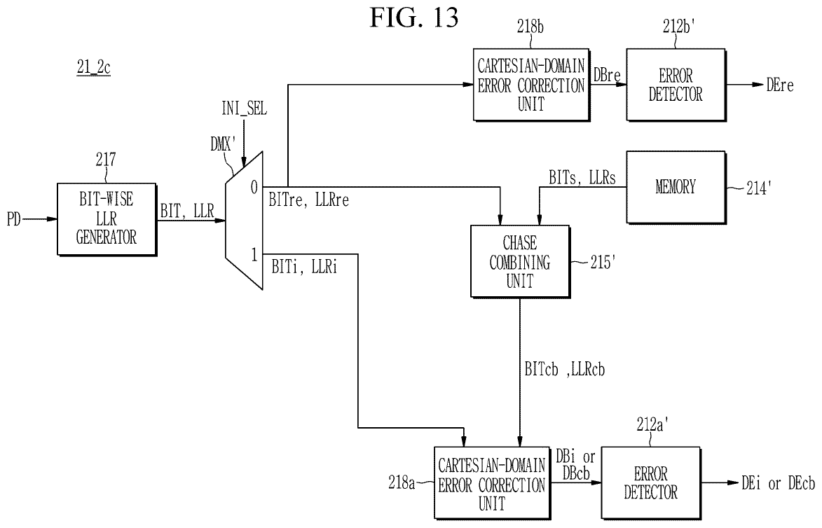

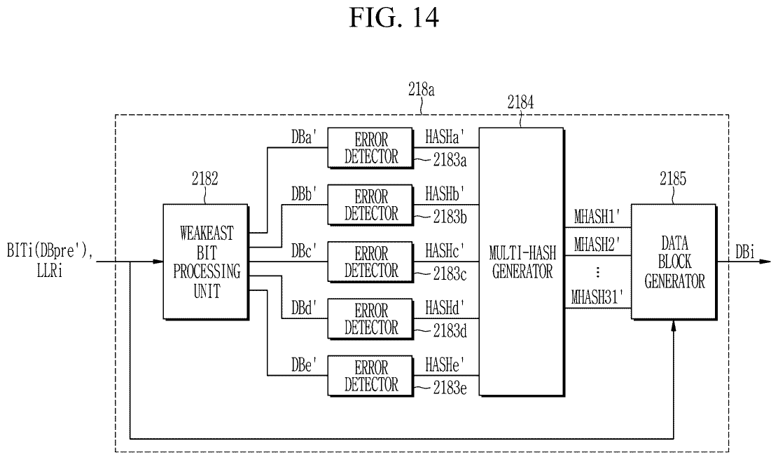

FIG. 13 illustrates a block diagram of an error correction module according to embodiments. FIG. 14 illustrates a phase-domain error correction unit according to embodiments. An error correction module 21_2c of FIG. 13 is an example of (e.g., may be used to implement) the error correction module 21 2 of FIG. 2. The bit-wise soft decision generator 217, the first and second Cartesian-domain error correction units 218a and 218b, the first and second error detectors 212a′ and 212b′, the memory 214′, the combining unit 215′, and the demultiplexer DMX′ of FIG. 13 may correspond to the symbol-wise soft decision generator 210, the first and second phase-domain error correction units 211a and 211b, the first and second error detectors 212a and 212b, the memory 214, the combining unit 215, and the demultiplexer DMX of FIG. 3, respectively. For better understanding and ease of description, the error correction module 21_2c of FIG. 13 will be described focusing on the differences from the corresponding configuration in FIG. 3.

Referring to FIG. 2, FIG. 13, and FIG. 14, the error correction module 21_2c may include a bit-wise soft decision generator 217, first and second Cartesian-domain error correction units 218a and 218b, first and second error detectors 212a′ and 212b′, a memory 214′, a combining unit 215′, and/or a demultiplexer DMX′.

The bit-wise soft decision generator 217 may perform a soft decision operation based on the phase difference data PD to generate bit data BIT in units of bits and bit reliability data LLR that is reliability data for the bit data BIT.

According to embodiments, the demodulator module 21 may receive the input signal IN_Pin a packet unit, and the bit-wise soft decision generator 217 may receive a plurality of successively received phase difference data PD (e.g., a plurality of pieces of successively received phase difference data PD). The bit-wise soft decision generator 217 may continuously generate a plurality of bit data BIT (e.g., a plurality of pieces of bit data BIT) and bit reliability data LLR (e.g., a plurality of pieces of bit reliability data LLR) based on the plurality of phase difference data PD.

According to embodiments, when the demodulator module 21 performs demodulation in a QDPSK manner, the bit-wise soft decision generator 217 may generate two bit data (e.g., two pieces of bit data or two bits of bit data) corresponding to different bit digits based on one phase difference data PD (e.g., one piece of phase difference data PD) inputted in units of symbols. According to embodiments, when the demodulator module 21 operates according to the Bluetooth EDR2 mode, the demodulator module 21 may perform demodulation using a QDPSK method.

According to embodiments, when the demodulator module 21 performs demodulation in an 8DPSK manner, the bit-wise soft decision generator 217 may generate three bit data (e.g., three pieces of bit data or three bits of bit data) corresponding to different bit digits based on one phase difference data PD inputted in units of symbols. According to embodiments, when the demodulator module 21 operates according to the Bluetooth EDR3 mode, the demodulator module 21 may perform demodulation using a 8DPSK method.

The bit reliability data LLR is data indicating a reliability value for the corresponding bit data BIT, and in embodiments, the bit reliability data LLR may be a log likelihood ratio. The bit reliability data LLR may be determined based on the phase difference value of the phase difference data PD, and the bit-wise soft decision generator 217 may generate the bit reliability data LLR by calculating a log likelihood ratio approximately for each bit data BIT (e.g., each piece of bit data BIT or each bit of bit data BIT). According to embodiments, the bit reliability data LLR may have a predetermined (or alternatively, given) number of bits.

The log likelihood ratio may mean a logarithm value with respect to a ratio of a posteriori probability (APP) value in which bit data BIT is logic high, ‘1’ and a posteriori probability value in which bit data BIT is logic low, ‘0’.

According to embodiments, when the bit reliability data LLR has a positive value, the bit data BIT may have a logic high of ‘1’, when the bit reliability data LLR has a negative value, the bit data BIT may have a logic low of ‘0’, and the larger the value of the bit reliability data LLR, the lower the probability of error occurrence of the bit data BIT.

For example, when the demodulator module 21 operates according to the Bluetooth EDR2 mode, the bit-wise soft decision generator 217 may perform a soft decision operation on the k-th phase difference data (k is an integer equal to or greater than 0), generate (k_1)-th bit data and (k_2)-th bit data corresponding to different bit digits, and generate (k_1)-th bit reliability data corresponding to the (k_1)-th bit data and (k_2)-th bit reliability data corresponding to the (k_2)-th bit data. For example, the bit-wise soft decision generator 217 may generate (k_1)-th bit reliability data and (k_2)-th bit reliability data by performing an operation as shown in Equation 1 below.

$$LLR ( {BIT}_{2 k} ) = - μ \cdot cos {θ}_{k} , \qquad ( Equation 1 )$$

$$LLR ( {BIT}_{2 k + 1} ) = - μ \cdot sin {θ}_{k}$$

In Equation 1, θₖ is a phase difference value of the k-th phase difference data, BIT₂ₖ is (k_1)-th bit data for the k-th phase data, BIT₂ₖ₊₁ is (k_2)-th bit data for the k-th phase difference data, LLR is bit reliability data for bit data, and μ is a predetermined (or alternatively, given) scaling coefficient.

For example, when the demodulator module 21 operates according to the Bluetooth EDR3 mode, the bit-wise soft decision generator 217 may perform a soft decision operation on the k-th phase difference data (k is an integer equal to or greater than 0), generate (k_1)-th bit data, (k_2)-th bit data, and (k_3)-th bit data corresponding to different bit digits, and generate (k_1)-th bit reliability data corresponding to the (k_1)-th bit data, (k_2)-th bit reliability data corresponding to the (k_2)-th bit data, and (k_3)-th bit reliability data corresponding to the (k_3)-th bit data. For example, the bit-wise soft decision generator 217 may generate (k_1)-th to (k_3)-th bit reliability data by performing an operation as shown in Equation 2 below.

$$LLR ( {BIT}_{3 k} ) = - μ \cdot cos ( {θ}_{k} + \frac{π}{8} ) , \qquad ( Equation 2 )$$

$$LLR ( {BIT}_{3 k + 1} ) = - μ \cdot sin ( {θ}_{k} + \frac{π}{8} ) ,$$

$$LLR ( {BIT}_{3 k + 2} ) = \vert μ \cdot sin ( {θ}_{k} + \frac{π}{8} ) \vert - \vert μ \cdot cos ( {θ}_{k} + \frac{π}{8} ) \vert$$

In Equation 2, θₖ is a phase difference value of the k-th phase difference data, BIT₃ₖ is (k 1)-th bit data for the k-th phase data, BIT₃ₖ₊₁ is (k_2)-th bit data for the k-th phase difference data, BIT₃ₖ₊₂ is (k_3)-th bit data for the k-th phase difference data, LLR is bit reliability data for bit data, and μ is a predetermined (or alternatively, given) scaling coefficient.

The demultiplexer DMX′ may receive the bit data BIT, the bit reliability data LLR, and the initial input selection signal INI_SEL, and operate as a data distributor to control the transmission path of the bit data BIT and the bit reliability data LLR based on the initial input selection signal INI_SEL.

For example, when the initial input selection signal INI_SEL is logic high, ‘1’, the demultiplexer DMX′ may check the bit data BIT and the input signal IN_P corresponding to the bit reliability data LLR as a signal based on the first input packet, and provide the bit data BIT and the bit reliability data LLR to the first Cartesian-domain error correction unit 218a as the first bit data BITi and the first bit reliability data LLR.

For example, when the initial input selection signal INI_SEL is logic low, ‘0’, the demultiplexer DMX′ may checks the bit data BIT and the input signal IN_P corresponding to the bit reliability data LLR as signals based on retransmitted packets, and may provide the bit data BIT and the bit reliability data LLR to the combining unit 215′ and the second Cartesian-domain error correction unit 218b as the retransmission bit data BITre and the retransmission bit reliability data LLRre.

The first Cartesian-domain error correction unit 218a may receive the initial bit data BITi and the initial bit reliability data LLRi, or the combining bit data BITcb and the combining bit reliability data LLRcb, which will be described later, to perform an error correction operation to output the initial data block DBi or the combining data block DBcb.

The first Cartesian-domain error correction unit 218a may include a weakest bit processing unit 2182, a plurality of error detectors 2183a to 2183e, a multi-hash generator 2184, and/or a data block generator 2185. The weakest bit processing unit 2182, the plurality of error detectors 2183a to 2183e, the multi-hash generator 2184, and the data block generator 2185 of FIG. 14 may correspond to the weakest bit processing unit 2112, the plurality of error detectors 2113a to 2113e, the multi-hash generator 2114, and the data block generator 2115 of FIG. 4, respectively.

The weakest bit processing unit 2182 may receive a plurality of initial bit data BITi (e.g., a plurality of pieces of initial bit data BITi) and a plurality of initial bit reliability data LLRi (e.g., a plurality of pieces of initial bit reliability data LLRi). According to embodiments, the weakest bit processing unit 2182 may receive the initial bit data BITi in the form of a data block DBpre′ before processing. The data block DBpre′ before processing may be a data block in which a plurality of initial bit data BITi inputted to the first Cartesian-domain error correction unit 218a in time order are consecutively connected, and may include a CRC code.

The weakest bit processing unit 2182 may select a plurality of weak bits in the data block DBpre′ before processing based on the plurality of initial bit reliability data LLRi, and flip one bit in the data block DBpre before processing to generate a data block.

For example, the weakest bit processing unit 2182 may select a predetermined (or alternatively, given) number of weak initial bit data (e.g., a number of pieces of weak initial bit data) from among the plurality of initial bit data BITi based on the plurality of initial bit reliability data LLRi. The weak initial bit data may mean bit data corresponding to reliability data with a smaller reliability value among the plurality of initial bit reliability data LLRi.

The weakest bit processing unit 2182 may flip one of different bits among the five selected weak bits to generate a-th to e-th processing data blocks DBa′ to DBe. According to embodiments, each of the a-th to e-th processing data blocks DBa′ to DBe′ may be a data block in which one bit is flipped based on the data block DBpre′ before processing. In embodiments, the a-th to e-th processing data blocks DBa′ to DBe′ may be different data blocks.

In FIG. 14, the number of selected weak bits is shown as 5, but the technical idea of present disclosure is not limited thereto, and the number of selected weak bits may vary depending on embodiments.

The plurality of error detectors 2183a to 2183e may receive the a-th to e-th processing data blocks DBa′ to DBe′, respectively, and perform an error detection operation to generate a-th to e-th hashes HASHa′ to HASHe′ as results of error detection for the a-th to e-th processing data blocks DBa′ to DBe′. The generated a-th to e-th hashes HASHa′ to HASHe′ may be provided to the multi-hash generator 2184. The a-th to e-th hashes HASHa′ to HASHe′ may correspond to the a-th to e-th hashes HASHa to HASHe of FIG. 4.

According to embodiments, the multi-hash generator 2184 may generate a plurality of multi-hashes MHASH1′ to MHASH31′ by outputting each of the a-th to e-th hashes HASHa′ to HASHe′ itself or performing an XOR operation on at least some of the a-th to e-th hashes HASHa′ to HASHe′. The plurality of multi-hashes MHASH1′ to MHASH31′ may correspond to the plurality of multi-hashes MHASH1 to MHASH31 of FIG. 4.

In FIG. 14, the first Cartesian-domain error correction unit 218a is only shown to perform an error correction operation based on the initial bit data BITi and the initial bit reliability data LLRi, but it is obvious that the components of the first Cartesian-domain error correction unit 218a of FIG. 14 may also perform an error correction operation based on the combining bit data BITcb and the combining bit reliability data LLRcb. According to embodiments, the first Cartesian-domain error correction unit 218a may generate the combining data block DBcb by performing an error correction operation based on the combining bit data BITcb and the combining bit reliability data BITcb.

Referring back to FIG. 13, the first error detector 212a′ may perform an error detection operation on the initial data block DBi or the combining data block DBcb to output the initial error decision data DEi or the combining error decision data DEcb.

The first error detector 212a′ may correspond to the a-th to e-th error detectors 2183a to 2183e of FIG. 14, and the initial error decision data DEi or the combining error decision data DEcb may correspond to the a-th to e-th hashes HASHA to HASHe of FIG. 14. For better understanding and ease of description, the description of the first error detector 212a′ may be replaced with the description of the a-th to e-th error detectors 2183a to 2183e of FIG. 14.

The second Cartesian-domain error correction unit 218b may receive the retransmission bit data BITre and the retransmission bit reliability data LLRre to perform an error correction operation to output the retransmission data block DBre.

The second Cartesian-domain error correction unit 218b may correspond to the first Cartesian-domain error correction unit 218a, the retransmission bit data BITre may correspond to the initial bit data BITi, the retransmission bit reliability data BITre may correspond to the initial bit reliability data BITi, and the retransmission data block DBre may correspond to the initial data block DBi. For better understanding and ease of description, the description of the second Cartesian-domain error correction unit 218b may be replaced with the description of the first Cartesian-domain error correction unit 218a.

The second error detector 212b′ may perform an error detection operation on the retransmission data block DBre to output the retransmission error decision data DEre.

The memory 214′ may store storage bit data BITs and storage bit reliability data LLRs for the storage bit data BITs. According to embodiments, the storage bit reliability data LLRs may be a log likelihood ratio and may have a predetermined (or alternatively, given) number of bits.

According to embodiments, the combining unit 215′ may receive retransmission bit data BITre and retransmission bit reliability data LLRre, and storage bit data BITs and storage bit reliability data LLRs, and perform a combining operation. The combining unit 215 may perform the combining operation to generate combining bit data BITcb and combining bit reliability data LLRcb for the combining bit data BITcb. According to embodiments, the combining bit reliability data LLRcb may be a log likelihood ratio and may have a predetermined (or alternatively, given) number of bits.

According to embodiments, the combining unit 215′ may perform a chase combining operation. According to embodiments, the combining unit 215′ may add the retransmission bit reliability data LLRre and the storage bit reliability data LLRs. According to embodiments, the combining unit 215′ may generate the combining bit reliability data LLRcb by multiplying the added reliability value by a predetermined (or alternatively, given) scaling coefficient.

The combining unit 215′ may determine the combining bit data BITcb based on the sign of the combining bit reliability data LLRcb. For example, when the combining bit reliability data LLRcb has a positive value, the combining bit data BITcb may have ‘1’, which is logic high, and when the combining bit reliability data LLRcb has a negative value, the combining bit data BITcb may have ‘0’, which is logic low.

According to embodiments, the error correction module 21_2c may perform an error detection operation on the retransmission data block DBre generated by performing an error correction operation in parallel on the retransmission packet, and may detect an error in the combining data block DBcb generated by performing an error correction operation after performing the combining operation. According to embodiments, the error correction module 21_2c may perform error correction and error detection on the retransmitted packets in parallel to improve the reception success rate of packet transmission.

According to embodiments, the first Cartesian-domain error correction unit 218a may generate the initial data block DBi by performing an error correction operation on the first input packet, and may generate the combining data block DBcb by performing an error correction operation on the combining bit data BITcb and the combining bit reliability data LLRcb on the retransmitted packet. According to embodiments, the error correction module 21_2c includes the first Cartesian-domain error correction unit 218a, thereby improving the reception success rate of packet transmission without adding a separate configuration and without area overhead.

According to embodiments, the error correction module 21_2c generates bit data BIT of the bit unit and corresponding bit reliability data LLR on the input phase difference data PD, and may perform a combining operation on a bit-by-bit basis and perform an error correction operation without a separate conversion operation.

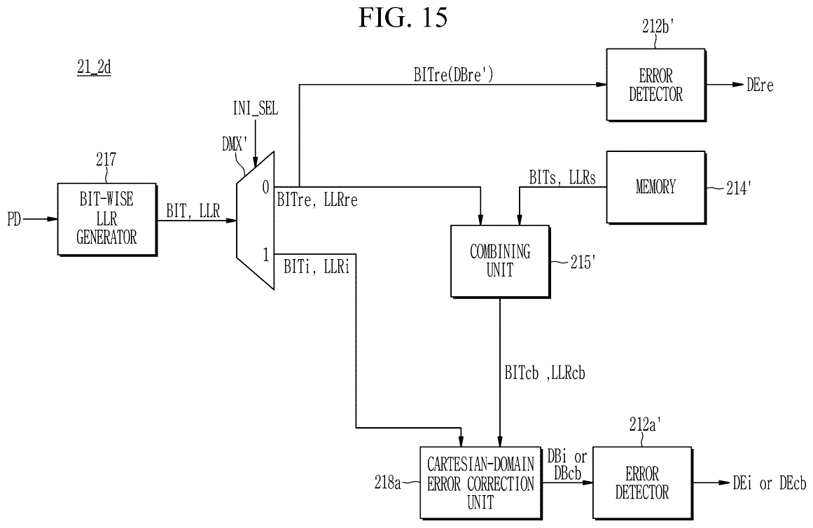

FIG. 15 illustrates a block diagram of an error correction module according to embodiments. An error correction module 21_2d of FIG. 15 is an example of (e.g., may be used to implement) the error correction module 21_2 of FIG. 2. For better understanding and ease of description, the error correction module 21_2d of FIG. 15 will be described focusing on the differences from the error correction module 21_2c of FIG. 13.

The second error detector 212b′ may receive the retransmission symbol data BITre from the demultiplexer DMX′ without a separate error correction operation.

According to embodiments, the second error detector 212b′ may receive the retransmission bit data BITre in the form of a retransmission data block DBre′ that is continuously inputted in time order without performing an error correction operation.

The error correction module 21_2d may detect an error in the retransmitted data block DBre′ in parallel on the retransmitted packet, and may detect an error in the combined data block DBcb generated by performing an error correction operation after performing the combining operation. According to embodiments, the error correction module 21_2d may improve the reception success rate of packet transmission by performing error correction and error detection on retransmission packets in a parallel manner while disposing one (e.g., only one) Cartesian-domain error correction module. Through the disposition of the Cartesian-domain error correction module as described above, the error correction module 21_2d may improve the area overhead and improve the reception success rate of packet transmission.

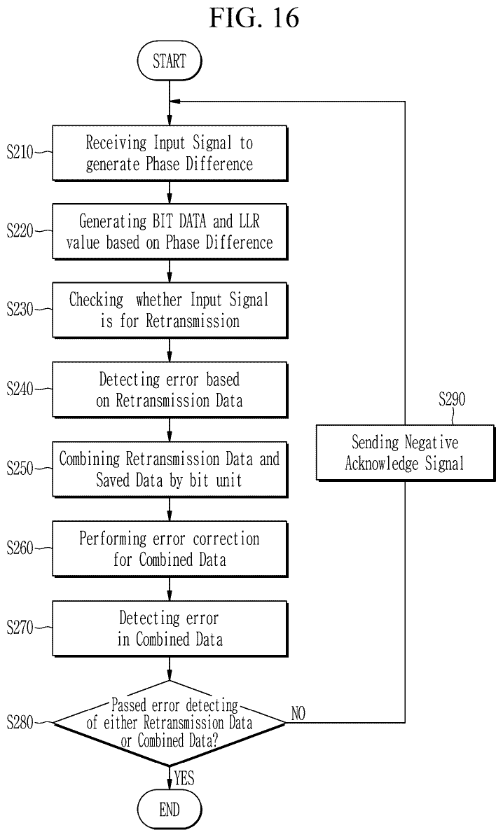

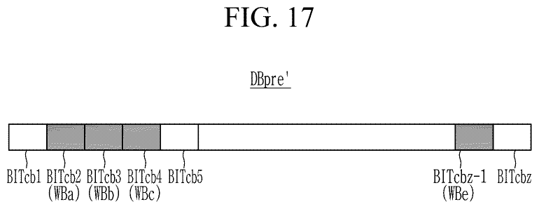

FIG. 16 illustrates a flowchart of an operating method of a demodulator module according to embodiments. FIG. 17 is a drawing for describing an operating method of a demodulator module according to embodiments. Specifically, FIG. 16 illustrates an error correction operation method of the demodulator module 21 for a retransmission packet. Operations S110 to S190 of FIG. 6 may correspond to operations S210 to S290 of FIG. 16 to be described later, respectively. For better understanding and ease of description, the operation method of FIG. 16 will be described below, focusing on differences from the operation method of FIG. 6.

Referring to FIG. 2 and FIG. 13 to FIG. 16, the phase difference calculating module 21_1 receives a plurality of input signals IN_P to generate phase difference data PD between the plurality of input signals IN_P (S210).

The bit-wise soft decision generator 217 performs a soft decision operation based on the phase difference data PD to generate bit data BIT in units of bits and bit reliability data LLR that is reliability data for the bit data BIT (S220).

According to embodiments, when the demodulator module 21 performs demodulation in a DPSK manner, the bit-wise soft decision generator 217 may generate one phase difference data PD (e.g., one piece of phase difference data PD) inputted in symbol units as a plurality of bit data BIT (e.g., a plurality of pieces of bit data BIT) corresponding to different bit digits.

According to embodiments, the bit reliability data LLR, which is the reliability data to the bit data BIT, may be a log likelihood ratio, and the bit-wise soft decision generator 217 may generate a reliability value of the bit reliability data LLR by calculating approximately the phase difference value of the phase difference data PD.

The demultiplexer DMX′ checks whether the input signal IN_P is retransmitted based on the initial input selection signal INI_SEL (S230).

The demultiplexer DMX′ may determine a transmission path for the generated bit data BIT and bit reliability data LLR according to the checking of whether the input signal IN_P is retransmitted.

When the input signal IN_P is based on the initially inputted packet, the demultiplexer DMX′ may provide the generated bit data BIT and the bit reliability data LLR to the first Cartesian-domain error correction unit 218a as the initial bit data BITi and the initial bit reliability data LLR.

When the input signal IN_P is based on the retransmitted packet, the demultiplexer DMX′ may provide the generated bit data BIT and the bit reliability data LLR in parallel. In the error correction module 21_2c of FIG. 13, the demultiplexer DMX′ may provide the generated bit data BIT and the bit reliability data LLR to the combining unit 215′ and the second Cartesian-domain error correction unit 218b in parallel as the retransmission bit data BITre and the retransmission bit reliability data LLRre. In the error correction module 21_2d of FIG. 15, the demultiplexer DMX′ may provide the generated bit data BIT and the bit reliability data LLR to the combining unit 215′ and the second error detector 212b′ in parallel as the retransmission bit data BITre and the retransmission bit reliability data LLRre.

The second error detector 212b detects an error in the retransmission data blocks DBre and DBre′ (S240).

In the error correction module 21_2c of FIG. 13, the retransmission data block DBre inputted to the second error detector 212b may be a data block generated by the second Cartesian-domain error correction unit 218b performing an error correction operation based on the retransmission bit data BITre and the retransmission bit reliability data LLRre.

In the error correction module 21_2d of FIG. 15, the retransmission data block DBre′ inputted to the second error detector 212b may be a data block generated by continuously inputting the retransmission bit data BITre in time order without performing an error correction operation.

The retransmission data blocks DBre and DBre′ may correspond to the retransmission data blocks DBre and DBre′ of FIG. 3 and FIG. 5, and the retransmission error decision data DEre may correspond to the retransmission error decision data DEre of FIG. 3 and FIG. 5.

The combining unit 215′ receives the retransmission bit data BITre, the retransmission bit reliability data LLRre, the storage bit data BITs, and the storage bit reliability data LLRs, and performs a combining operation in bit units (S250).

The combining unit 215′ may receive the retransmission bit data BITre and the retransmission bit reliability data LLRre outputted from the demultiplexer DMX′ as it is.

The combining unit 215′ may perform a chase combining operation on the retransmitted bit data BITre, the storage bit data BITs corresponding to the retransmitted bit reliability data LLRre, and the storage bit reliability data LLRs.

According to embodiments, the combining unit 215′ may add the retransmission bit reliability data LLRre and the corresponding storage bit reliability data LLRs. The combining unit 215′ may multiply the added value by a predetermined (or alternatively, given) scaling coefficient, and may generate the multiplied value as combining bit reliability data LLRcb.

When the value multiplied by the predetermined (or alternatively, given) scaling coefficient is a positive value, the combining unit 215′ may generate combining bit data BITcb with ‘1’. Conversely, when the value multiplied by the predetermined (or alternatively, given) scaling coefficient is a negative value, the combining unit 215′ may generate combining bit data BITcb with ‘0’.

The combining unit 215′ may provide the generated combining bit data BITcb and the combining bit reliability data LLRcb to the first Cartesian-domain error correction unit 218a without a separate processing operation.

The first Cartesian-domain error correction unit 218a receives the combining bit data BITcb and the combining bit reliability data BITcb to perform an error correction operation to generate combining data block DBcb (S260).

The first Cartesian-domain error correction unit 218a may receive the initial bit data BITi in the form of a data block DBpre′ before processing, based on the combining bit data BITcb and the combining bit reliability data BITcb.

FIG. 17 illustrates an operation example of the first Cartesian-domain error correction unit 211a.

Referring additionally to FIG. 17, the first Cartesian-domain error correction unit 218a may generate a data block DBpre′ before processing based on a plurality of combining bit data BITcb1 to BITcbz (e.g., a plurality of pieces of combining bit data BITcb1 to BITcbz) that are consecutively inputted. The first Cartesian-domain error correction unit 218a may select a weak bit based on the combining bit reliability data corresponding to the plurality of combining bit data BITcb1 to BITcbz.

For example, the first Cartesian-domain error correction unit 218a may select the second combining bit data BITcb2 as the a-th weak bit WBa, may select the third combining bit data BITcb3 as the b-th weak bit WBb, may select the fourth combining bit data BITcb4 as the c-th weak bit WBc, and may select the (z-1)-th combining bit data BITcbz-1 as the e-th weak bit WBe. According to embodiments, the first Cartesian-domain error correction unit 218a may select the consecutive second to fourth combining bit data BITcb2 to BITcb4 as the a-th to c-th weak bits WBa to WBc.

The first Cartesian-domain error correction unit 218a may flip one of the selected a-th to e-th weak bits WBa to WBe to generate the a-th to e-th processing data blocks DBa′ to DBe′. Referring to FIG. 17 as an example, the first Cartesian-domain error correction unit 218a may generate the a-th processing data block DBa by flipping the second combining bit data BITcb2 in the data block DBpre′ before processing.

The first Cartesian-domain error correction unit 218a may perform an error detection operation on the a-th to e-th processing data blocks DBa′ to DBe′, respectively, to generate a-th to e-th hashes HASHa′ to HASHe′ as a result of error detection on the a-th to e-th processing data blocks DBa′ to DBe′.

According to embodiments, the first Cartesian-domain error correction unit 218a may generate a plurality of multi-hashes MHASH1′ to MHASH31′ by generating each of the a-th to e-th hashes HASHa′ to HASHe′ itself or performing an XOR operation on at least some of the a-th to e-th hashes HASHa′ to HASHe′.

The first Cartesian-domain error correction unit 218a may generate a combining data block DBcb by performing an error correction operation of flipping some bit data of the data block DBpre′ before processing based on the plurality of multi-hashes MHASH1′ to MHASH31′. When the error correction operation cannot be (e.g., is unable to be) performed, the first Cartesian-domain error correction unit 218a may generate the data block DBpre′ itself before processing as the combining data block DBcb.

The first error detector 212a′ detects an error of the combining data block DBcb (S270).

The first error detector 212a′ may receive the combining data block DBcb and perform error detection to generate combining error decision data DEcb as a result of error detection for the combining data block DBcb.

In FIG. 16, it is illustrated that the operation S240 precedes the operations S250 to S270, but the order is for ease of description, and the technical idea of the present disclosure is not limited thereto. In embodiments, the operations S250 to S270 may be performed prior to or simultaneously (or contemporaneously) with the operation S240.

The demodulator module 21 checks whether at least one of the retransmission data blocks DBre and DBre′ and the combining data block DBcb passes the error detection operation based on the retransmission error decision data DEre and the combining error decision data DEcb (S280).

When the retransmission error decision data DEre and the combining error decision data DEcb include error detection of the retransmission data blocks DBre and DBre′ and the combining data block DBcb, the second communication device 20 provides a negative acknowledgment NACK to the first communication device 10 to request retransmission (S290).

After providing the negative acknowledgment NACK, the second communication device 20 may repeat the operations S210 to S280.

According to embodiments, the error correction modules 21_2c and 21_2d may perform the operation S240 and the operations S250 to S270 in a parallel manner for the retransmission packet to improve the reception success rate of the packet transmission.

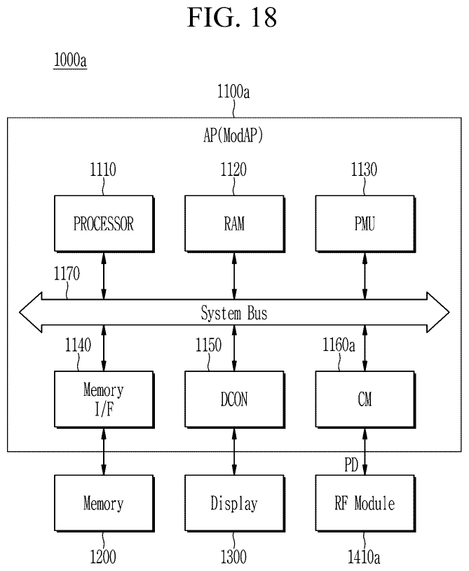

FIG. 18 is a drawing for describing a wireless communication device according to embodiments.

Referring to FIG. 18, a wireless communication device 1000a may include an application processor 1100a (hereinafter referred to as AP), a memory 1200, a display 1300, and/or an RF module 1410a. In addition, the wireless communication device 1000a may further include various components such as a lens, a sensor, an audio module, and the like.

The AP 1100a may be implemented as a system-on-chip (SoC), and may include a processor 1110, a RAM 1120, a power management unit (PMU), a memory interface 1140, a display controller 1150, a communication module 1160a, and/or a bus 1170. The AP 1100a may further include various IPs. The processor 1110, the RAM 1120, the PMU 1130, the memory interface 1140, the display controller 1150, and/or the communication module 1160a may be connected to each other through a bus 1170 and may perform internal data communication. The AP 1100a may be referred to as a ModAP as the function of a communication module chip is integrated therein.

The processor 1110 may control the overall operations of the AP 1100a and the wireless communication device 1000a. The processor 1110 may control the operation of each component of the AP 1100a. In addition, the processor 1110 may include a multi-core. The multi-core may be one computing component having two or more independent cores.

The RAM 1120 may temporarily store programs, data, or instructions. For example, programs and/or data stored in the memory 1200 may be temporarily stored in the RAM 1120 according to the control or booting code of the processor 1110. The RAM 1120 may be implemented as a DRAM or an SRAM.

The PMU 1130 may manage power of each component of the AP 1100a. The PMU 1130 may also determine an operation state of each component of the AP 1100a and control an operation thereof.

The memory interface 1140 may control the overall operation of the memory 1200 and control data exchange between each component of the AP 1100a and the memory 1200. The memory interface 1140 may write data to or read data from the memory 1200 according to a request from the processor 1110.

The display controller 1150 may transmit image data to be displayed on the display 1300 to the display 1300. The display 1300 may be implemented as a flat panel display or a flexible display such as a liquid crystal display (LCD), an organic light emitting diode (OLED), or the like.

For wireless communication, the communication module 1160a may modulate data to be transmitted to be suitable for the wireless environment and demodulate received data. According to embodiments, the demodulated data may be provided to the processor 1110.

The communication module 1160a may perform digital communication with the RF module 1410a, and may include the error correction module 21_2 of FIG. 1 to FIG. 17 to partially perform a modulation or demodulation operation. The communication module 1160a may improve the reception success rate of packet transmission by performing error correction and error detection on the retransmission packet in a parallel manner through the error correction module 21_2 of FIG. 1 to FIG. 17.

The RF module 1410a may correspond to the transceivers 12 and 22 of FIG. 1. The RF module 1410a may convert an RF signal received through an antenna into a baseband signal, and partially perform a demodulation operation on the converted baseband signal to generate the phase difference data PD. The phase difference data PD may be provided to the communication module 1160a. In addition, the RF module 1410a may modulate the phase difference data PD received from the communication module 1160a into a baseband signal, convert the baseband signal into an RF signal, and transmit the converted RF signal to the outside of the wireless communication device 1000a through an antenna. In addition, the RF module 1410a may amplify or filter signals.

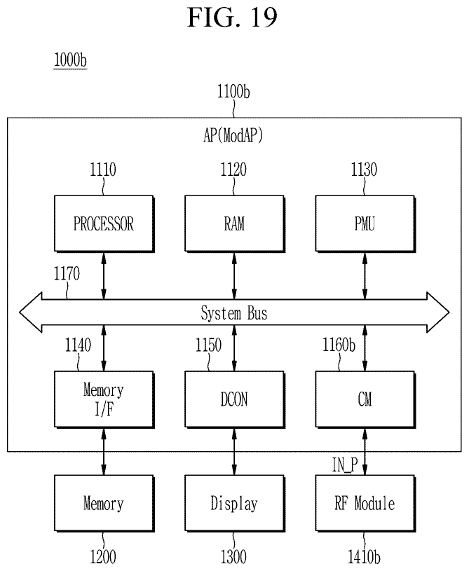

FIG. 19 is a drawing for describing a wireless communication device according to embodiments. A wireless communication device 1000b of FIG. 19 may correspond to the wireless communication device 1000a of FIG. 18, and an AP 1100b, a communication module 1160b, and an RF module 1410b of FIG. 19 may correspond to the AP 1100a, the communication module 1160a, and the RF module 1410a of FIG. 18, respectively. For better understanding and ease of description, the wireless communication device 1000b of FIG. 19 will be described focusing on the differences from FIG. 18.

Referring to FIG. 19, the wireless communication device 1000b may include an AP 1100b, a memory 1200, a display 1300, and/or an RF module 1410b, and the AP 1100b may include a processor 1110, a RAM 1120, a PMU 1130, a memory interface 1140, a display controller 1150, a communication module 1160b, and/or a bus 1170.

The communication module 1160b may perform digital communication with the RF module 1410b, and may include the modulator module and the demodulator module 21 of FIG. 1 to FIG. 17 to perform a modulation or demodulation operation. The communication module 1160b may improve the reception success rate of packet transmission by performing error correction and error detection on the retransmission packet in a parallel manner through the demodulator module 21 of FIG. 1 to FIG. 17.

The RF module 1410b may correspond to the transceivers 12 and 22 of FIG. 1. The RF module 1410b may convert an RF signal received through an antenna into a baseband signal and generate an input signal IN_P that is the converted baseband signal. The input signal IN_P may be provided to the communication module 1160b. In addition, the RF module 1410b may convert the input signal IN_P, which is a baseband signal received from the communication module 1160a, into an RF signal, and transmit the converted RF signal to the outside of the wireless communication device 1000a through an antenna. In addition, the RF module 1410b may amplify or filter signals.

Conventional devices and methods for performing error detection on received packets involve performing a Cyclic Redundancy Check (CRC) based on a corresponding code in a received packet, and by performing Hybrid Automatic Repeat Request (HARQ) based on detection of an uncorrectable error. However, the conventional devices and methods are unable to perform error correction using the CRC code on packets that have been retransmitted according to HARQ. Accordingly, the conventional devices and methods suffer from an insufficient packet reception success rate.

However, according to embodiments, improved devices and methods are provided for performing error detection on received packets. For example, the improved devices and methods include performing error correction (e.g., CRC correction) on retransmitted packets separately and/or combined with data from a previously received packet. Accordingly, the improved devices and methods overcome the deficiencies of the conventional devices and methods to at least improve the packet reception success rate.

According to embodiments, operations described herein as being performed by the communication system 1, the first communication device 10, the second communication device 20, the modulator module 11, the transceiver 12, the demodulator module 21, the transceiver 22, the phase difference calculating module 21_1, the error correction module 21_2, the symbol-wise soft decision generator 210, each of the first and second phase-domain error correction units 211a and 211b, each of the first and second error detectors 212a and 212b, the bit-wise soft decision generator 213, the combining unit 215, the bit-to-symbol soft decision converter 216, the demultiplexer DMX, the weakest symbol searching unit 2111, the weakest bit processing unit 2112, each of the plurality of error detectors 2113a to 2113e, the multi-hash generator 2114, the data block generator 2115, the error correction module 21_2b, the error correction module 21_2c, the bit-wise soft decision generator 217, each of the first and second Cartesian-domain error correction units 218a and 218b, each of the first and second error detectors 212a′ and 212b′, the combining unit 215′, the demultiplexer DMX′, the error correction module 21_2d, the wireless communication device 1000a, the application processor 1100a, the RF module 1410a, the processor 1110, the power management unit (PMU) 1130, the memory interface 1140, the display controller 1150, the communication module 1160a, the wireless communication device 1000b, the AP 1100b, the RF module 1410b, and/or the communication module 1160b may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

While embodiments of the present disclosure have been described in connection with what is presently considered to be practical examples, it is to be understood that the disclosure is not limited to the disclosed examples, but, on the contrary, is intended to cover various modifications and equivalent arrangements included within the spirit and scope of the appended claims.

1. A communication module comprising:
processing circuitry configured to
control a transmission path of first data and first reliability data according to whether a plurality of input signals were retransmitted, the first data being generated based on phase difference data between the plurality of input signals inputted in time order, and the first reliability data corresponding to the first data,
detect an error in a first data block based on the first data and the first reliability data,
perform a combining operation on the first data, the first reliability data, storage data and storage reliability data to generate combining data and combining reliability data, the storage reliability data corresponding to the storage data, and the combining reliability data corresponding to the combining data, and
perform a first error correction operation based on the combining data and the combining reliability data.

2. The communication module of claim 1, wherein the processing circuitry is configured to generate the first data and the first reliability data based on the phase difference data, the first data and the first reliability data being in symbol units.

3. The communication module of claim 2, wherein the processing circuitry is configured to generate first bit data, second bit data, first bit reliability data and second bit reliability data based on the first data and the first reliability data, the first bit data and the second bit data being in bit units, the first bit reliability data corresponding to the first bit data, and the second bit reliability data corresponding to the second bit data.

4. The communication module of claim 3, wherein
the storage data includes first storage bit data and second storage bit data in bit units;
the storage reliability data includes first storage reliability data corresponding to the first storage bit data and second storage reliability data corresponding to the second storage bit data; and
the processing circuitry is configured to perform the combining operation on the first bit data and the first storage bit data, the first storage bit data corresponding to the first bit data.

5. The communication module of claim 4, further comprising:
a memory configured to store the first storage bit data, the second storage bit data, the first storage reliability data and the second storage reliability data.

6. The communication module of claim 2, wherein the processing circuitry is configured to perform a second error correction operation based on the first data and the first reliability data to generate the first data block.

7. The communication module of claim 6, wherein
the combining data includes first combining bit data and second combining bit data in bit units; and
the combining reliability data includes first combining bit reliability data corresponding to the first combining bit data and second combining bit reliability data corresponding to the second combining bit data.

8. The communication module of claim 7, wherein the processing circuitry is configured to:
generate combining symbol data and combining symbol reliability data based on the first combining bit data, the second combining bit data, the first combining bit reliability data and the second combining bit reliability data, the combining symbol data being in symbol units, and the combining symbol reliability data corresponding to the combining symbol data; and
perform the first error correction operation based on the combining symbol data and the combining symbol reliability data to generate a combining data block.

9. The communication module of claim 2, wherein
the first data corresponds to one of first to fourth symbols, each of the first to fourth symbols being different from each other.

10. The communication module of claim 2, wherein
the first data corresponds to one of first to eighth symbols, each of the first to eighth symbols being different from each other.

11. The communication module of claim 1, wherein the processing circuitry is configured to control the transmission path of the first data and the first reliability data based on a selection signal to detect the error in the first data block and perform the first combining operation based on the selection signal being in a first logic state.

12. The communication module of claim 11, wherein the processing circuitry is configured to control the transmission path of the first data and the first reliability data based on the selection signal to perform a third error correction operation to generate a second data block based on the selection signal being in a second logic state different from the first logic state, the third error correction operation being based on the first data and the first reliability data.

13. The communication module of claim 1, wherein the processing circuitry is configured to generate the first data and the first reliability data based on the phase difference data, the first data and the first reliability data being in bit units.

14. A communication module comprising:
processing circuitry configured to
generate bit data and bit reliability data based on phase difference data between a plurality of input signals inputted in time order, the bit reliability data corresponding to the bit data,
control a transmission path of the bit data and the bit reliability data depending on whether the plurality of input signals were retransmitted,
detect an error in a first data block based on the bit data and the bit reliability data,
perform a combining operation on the bit data and storage bit data to generate combining bit data, the storage bit data corresponding to the bit data,
perform a combining operation on the bit reliability data and storage bit reliability data to generate combining bit reliability data, the storage bit reliability data corresponding to the bit reliability data, and
perform an error correction operation based on the combining bit data and the combining bit reliability data.

15. The communication module of claim 14, wherein
the bit reliability data, the storage bit reliability data, and the combining bit reliability data are log-likelihood ratios (LLR).

16. The communication module of claim 15, wherein
the bit data includes first bit data and second bit data generated based on phase difference data, the first bit data and the second bit data corresponding to different bit digits;
the bit reliability data includes first bit reliability data for the first bit data and second bit reliability data for the second bit data; and
the bit reliability data is calculated by Equation 1 below,
$$LLR ( {BIT}_{2 k} ) = - μ \cdot cos {θ}_{k} , \qquad ( Equation 1 )$$
$$LLR ( {BIT}_{2 k + 1} ) = - μ \cdot sin {θ}_{k}$$
wherein in Equation 1, LLR is the bit reliability data, θₖ is a phase difference value of a k-th phase difference data, k is an integer greater than or equal to 0, BIT₂ₖ is the first bit data for the k-th phase difference data, BIT₂ₖ₊₁ is the second bit data for the k-th phase difference data, and μ is a scaling coefficient.

17. The communication module of claim 15, wherein
the bit data includes first bit data, second bit data and third bit data generated based on phase difference data, the first bit data, the second bit data and the third bit data corresponding to different bit digits;
the bit reliability data includes first bit reliability data for the first bit data, second bit reliability data for the second bit data, and third bit reliability data for the third bit data; and
the bit reliability data is calculated by Equation 2 below,
$$LLR ( {BIT}_{3 k} ) = - μ \cdot cos ( {θ}_{k} + \frac{π}{8} ) , \qquad ( Equation 2 )$$
$$LLR ( {BIT}_{3 k + 1} ) = - μ \cdot sin ( {θ}_{k} + \frac{π}{8} ) ,$$
$$LLR ( {BIT}_{3 k + 2} ) = \vert μ \cdot sin ( {θ}_{k} + \frac{π}{8} ) \vert - \vert μ \cdot cos ( {θ}_{k} + \frac{π}{8} ) \vert$$
wherein in Equation 2, LER is the bit reliability data, θₖ is a phase difference value of a k-th phase difference data, k is an integer greater than or equal to 0, BIT₃ₖ is the first bit data for the k-th phase difference data, BIT₃ₖ₊₁ is the second bit data for the k-th phase difference data, BIT₃ₖ₊₂ is the third bit data for the k-th phase difference data, and μ is a scaling coefficient.

18. An operating method of a communication module, comprising:
generating first data and first reliability data based on phase difference data between a plurality of input signals inputted in time order, the first reliability data corresponding to the first data;
detecting an error in a first data block based on the first data and the first reliability data in response to determining the plurality of input signals were retransmitted;
performing a combining operation on the first data, the first reliability data, storage data and storage reliability data to generate combining data and combining reliability data in response to determining the plurality of input signals were retransmitted, the storage reliability data corresponding to the storage data, and the combining reliability data corresponding to the combining data; and
performing an error correction operation based on the combining data and the combining reliability data to generate a combining data block;
detecting an error in the combining data block; and
requesting retransmission depending on whether at least one of error detection of the combining data block or error detection of the first data block succeeds.

19. The operating method of the communication module of claim 18, wherein
the first data is data in symbol units;
the storage data is data in bit units; and
the combining operation includes generating first bit data, second bit data, first bit reliability data, and second bit reliability data based on the first data and the first reliability data, the first bit data and the second bit data being in bit units, the first bit reliability data corresponding to the first bit data, and the second bit reliability data corresponding to the second bit data.

20. The operating method of the communication module of claim 18, wherein
the first data is data in bit units; and
the first reliability data is a log-likelihood ratio.

21. (canceled)
